(19) United States
(12) Patent Application Publication
(10) Pub. No.: US 2026/0335898 A1
(43) Pub. Date: Oct. 29, 2026

(54) METHOD AND DEVICE FOR PRODUCING A FOIL-COVERED WORKPIECE

(71) Applicant: GREINER BIO-ONE GMBH, Frickenhausen (DE)

(72) Inventors: Rainer HELLER, Tübingen (DE); Jochen KUTTIG, Gomaringen (DE); Peter PETERSEN, Rudersberg (DE); Peter KLUGE, Notzingen (DE); Matthias JÜNGLING, Notzingen (DE)

(21) Appl. No.: 19/116,004

(22) PCT Filed: Sep. 27, 2023
(86) PCT No.: PCT/EP2023/076769

§ 371 Date: Mar. 27, 2025

(30) Foreign Application Priority Data
Sep. 30, 2022 (DE) 102022210453.6

(51) Int. Cl. B01L 3/00

(52) U.S. Cl. CPC B01L 3/50853; B01L 2200/0689; B01L 2200/12; B01L 2300/041; B01L 2300/0829

(57) ABSTRACT

The present invention relates to a method for producing a foiled workpiece, a foiled workpiece producible by the method according to the invention, a system comprising at least one foiled workpiece and an apparatus for producing a foiled workpiece.

The present invention relates to a method for producing a foiled workpiece, a foiled workpiece producible by the method according to the invention, a system comprising at least one foiled workpiece and an apparatus for producing a foiled workpiece.

Multiwell plates are used in research and industry to carry out many cell biological, microbiological and biochemical experiments. Multiwell plates are in particular characterized by a plurality of regularly arranged cavities (wells). In order to cover the widest possible range of applications, a variety of plate designs is available. Plate formats with 6 (2×3 matrix) to 96 (8×12 matrix) wells are particularly frequently used in cell biology. Plates with a higher format, such as plates with 384 wells (16×24 matrix) or more, are often used for biochemical tests. The arrangement of the individual wells of the multiwell plates in relation to each other, their outer and inner dimensions, as well as the dimensions of the plates themselves are nowadays standardized (ANSI standards). In this way, it easy to automate test procedures, for example by using pipetting robots, reading out measurement results using a plate reader and/or automated microscopy. Furthermore, standardization allows the use of different inserts and attachments for the various multiwell plates available on the market.

A special field of application for multiwell plates is the use of plates with foil bottoms, in particular with membrane bottoms. The membrane bottoms can be used to form separate reaction chambers (compartmentalization), for filtration (separation of solid and liquid components) or as a surface for the adhesion of cells, chemical molecules or biomolecules. The membrane bottom plates used for this purpose are characterized by the fact that they comprise a plurality of wells, wherein the bottom of each well comprises a porous, impermeable, semi-permeable or permeable barrier layer, in particular a membrane. This barrier layer, in particular a membrane, can, for example, allow the selective passage of ions or organic molecules, such as certain active compounds, or biomolecules, such as growth factors, peptides, proteins, hormones or enzymes.

Membrane bottom plates are conventionally used as cell culture inserts for processing complex questions in cell and tissue culture. Fields of application for such cell culture inserts include, for example, migration or invasion studies, transport assays, co-cultures or the cultivation of complex three-dimensional tissue structures, such as epithelial or skin cells, including so-called air-liquid interface (ALI) cultures. The tissue structures formed can be used in subsequent biological, such as toxicological, tests, or in physical test systems, such as transepithelial/transendothelial electrical resistance (TEER) or impedance measurements.

In the simplest case, membrane bottom plates are used for filtration applications. The membrane at the bottom of the individual wells serves to separate solid components of a sample from the liquid components. For this purpose, a membrane with a pore size is selected which retains solid components that exceed a certain hydrodynamic diameter and allows the passage of liquids and solid components with a smaller hydrodynamic diameter.

When using membrane bottom plates, it is particularly important to ensure that there is no cross-contamination between the samples or rather between the different chambers of the individual cavities of the membrane bottom plate. If, for example, the bottoms of the individual cavities of the membrane bottom plate are formed by a single continuous permeable membrane, such membrane provides a connection between the cavities and allows cross-contamination via capillary forces.

Membrane bottom plates are usually manufactured in two steps. In a first step, a membrane and a multiwell plate are provided, wherein the individual cavities of the multiwell plate have at least one opening at the bottom. In a next step, the membrane is joined to the multiwell plate such that the at least one opening at the bottom of the individual cavities is sealed by the membrane. Various methods are available for bonding the material of the membrane to the material of the multiwell plate. For example, adhesives could be used to bond the membrane to the bottom of the cavities of a multiwell plate. Another possibility is to join the components together using ultrasonic welding. Especially when handling biological samples, it is desirable that the components are joined as solvent-free and residue-free as possible.

A method for bonding a polymer film to a cell cultivation device is disclosed in EP 2 611 539 B 1 . According to the method described therein, the connection between the cell cultivation device and the polymer film is made by pressing the polymer foil onto the device by means of a silicone stamp which has been heated to a temperature which is at least 100 °C above the glass transition temperature of the material of the device or of the device and the polymer foil. In this way, at least one of the two materials to be joined is melted such that the polymer foil firmly seals the bottom of the cavities of the cell cultivation device after the materials have cooled down.

The present invention is based on the technical problem of providing a method for producing a foiled workpiece, in particular a membrane bottom plate, which is as simple and efficient as possible, which overcomes the problems of the methods in the prior art, and in particular allows to produce a foiled workpiece, in particular a membrane bottom plate, which comprises individual foil areas, in particular membrane areas, which are bonded solvent-free and residue-free to at least one part of the workpiece to be foiled, in particular to the bottom of the cavities of the workpiece, in particular of the membrane bottom plate, and which have a particularly high flatness or planarity, respectively, compared to the prior art.

In the context of the present invention, the term “cavity” refers to a hollow space defined by a wall. In a particularly preferred embodiment of the present invention, a “cavity” is a well of a plate, in particular of a multiwell plate.

In the context of the present invention, the term “foil” is understood to mean a single or multi-layered, thin, flat structure. A “foil” can be composed of a single material or of several materials. According to the invention, a “foil” can, for example, comprise materials, individually or in combination or as a mixture, selected from: metals, plastics, natural or artificial polymers, fibers, filaments, polysaccharides, polypeptides. The term thus includes for example metal foils, plastic foils, in particular polymer foils, but also nonwovens consisting of one or more materials, in particular fibrous nonwovens, such as paper, as well as fabric foils and nonwoven fabrics. The “foil” may be transparent or translucent or opaque. In the context of the present invention, a “foil” can be mono-or unidirectionally permeable, in particular omnipermeable, semi-permeable, selectively permeable, as well as non-permeable. The “foil” may be coated or uncoated. In a particularly preferred embodiment, the “foil” is a “membrane”.

In the context of the present invention, the term “membrane” refers to a “foil” which has a certain permeability for one or more substances, in particular is at least selectively permeable, i.e. has at least a selective permeability for one or more substances.

In the context of the present invention, a “foil area” or “membrane area” is understood to mean a spatially limited section of a foil or membrane.

In the context of the present invention, an “outer contour” is understood to be the outline of an object that delimits the object from its surroundings. In contrast, an “inner contour” is understood to mean the demarcation from an inner space of an object. Thus, according to the invention, the expression “outer contour of the open end of the at least one cavity” refers to the outline of the structure forming the open end of the cavity. The term “inner contour of the open end of the at least one cavity” describes the inner outline of the structure forming the open end of the cavity, respectively.

The term “punching” refers to a material recess created by exerting pressure. Particularly preferred, the at least one “punching” by which the at least one foil area or the at least one membrane area, is delimited is produced by means of a cutting die with correspondingly shaped cutting edges.

According to the invention, the term “flatness tolerance” refers to the tolerable deviation of the flatness or planarity, respectively, of a surface from an ideal flat surface. The tolerance limits are defined by two imaginary planes, each of which is parallel to an ideal flat surface and which have a distance from each other that corresponds to the value of the “flatness tolerance”. For example, a “flatness tolerance” of 100 μm refers to maximum measurable distance between the maximum positive and the maximum negative deviation from the ideal flat surface over the entire foil area, in particular the entire membrane area. The maximum distance of 100 μm can, for example, result from a maximum positive deviation (bulge) of 80 μm (+80 μm) in relation to the ideal flat surface and a maximum negative deviation (indentation) of 20 μm (−20 μm) in relation to the ideal flat surface.

According to the invention, the “averaged flatness tolerance” refers to the arithmetic mean of the individual “flatness tolerances” of the foil areas, in particular of the membrane areas, of a foiled workpiece, in particular of a membrane bottom plate. In contrast to a “flatness tolerance of 100 μm”, an “averaged flatness tolerance of 100 μm” allows the distance between the maximum positive and the maximum negative deviation from the ideal flat surface for individual foil areas, in particular for individual membrane areas, of the foiled workpiece, in particular of the membrane bottom plate, to be greater than 100 μm, provided that the distance averaged over all foil areas, in particular over all membrane areas, of the foiled workpiece, in particular of the membrane bottom plate, is at most 100 μm. This means that the distance between the maximum positive and the maximum negative deviation from the ideal flat surface for one or more foil areas, in particular membrane areas, of the foiled workpiece, in particular of the membrane bottom plate, can, for example, be slightly more than 100 μm provided that the distance between the maximum positive and the maximum negative deviation from the ideal flat surface for other foil areas, in particular membrane areas, of the foiled workpiece, in particular of the membrane bottom plate, is less than 100 μm and that the distance averaged over all foil areas, in particular over all the membrane areas, of the foiled workpiece, in particular of the membrane bottom plate, is at most 100 μm.

According to a preferred embodiment of the invention, the measurement of the flatness or planarity, respectively, of a surface, in particular the maximum positive and the maximum negative deviation from an ideal flat surface, can be done by means of white light interferometry (WLI), in particular using a chromatic white light sensor.

In the context of the present invention, the terms “comprising” and “including” are understood to mean that in addition to the elements explicitly covered by these terms, further elements not explicitly mentioned may be added. In the context of the present invention, these terms are also understood to mean that only the explicitly mentioned elements are included and that no further elements are present. In this particular embodiment, the meaning of the terms “comprising” and “including” is synonymous with the term “consisting of”. Furthermore, the terms “comprising” and “including” also cover compositions which, in addition to the explicitly mentioned elements, also contain other elements which are not mentioned but which are of a functionally and qualitatively subordinate nature. In this embodiment, the terms “comprising” and “including” are synonymous with the term “consisting essentially of”.

In connection with the present invention, the term “and/or” is understood to mean that all members of a group which are connected by the term “and/or” are disclosed, both as alternatively to one another and cumulatively to one another in any combination. This means for the expression “A, B and/or C” that the following disclosure content is to be understood: a) A or B or C or b) (A and B) or c) (A and C) or d) (B and C) or e) (A and B and C).

The present invention solves the problem on which it is based by the subject-matter of the independent claims. In particular, the invention relates to method for producing a foiled workpiece, comprising the steps of:
a) providing a workpiece made of a first material,
b) providing a foil, in particular a membrane, made of a second material, wherein the foil, in particular the membrane, has at least one foil area, in particular at least one membrane area, which is delimited by at least one punching, and wherein the at least one foil area, in particular the at least one membrane area, is held in the foil, in particular in the membrane, by means of at least one connection,
c) contacting the workpiece with the foil, in particular with the membrane, such that the at least one foil area, in particular the at least one membrane area, of the foil, in particular of the membrane, comes into congruence with a part of the workpiece to be foiled,
d) contacting a stamp with the foil, in particular with the membrane, such that the at least one foil area, in particular the at least one membrane area, bonds with the workpiece and seals the part of the workpiece to be foiled, wherein the stamp has a temperature which is above the glass transition temperature of the first and/or second material, and
e) removing the heated stamp to obtain a foiled workpiece.

According to a preferred embodiment of the present invention, the workpiece provided in step a) is a plate, in particular a multiwell plate.

Particularly preferred, the workpiece provided in step a), in particular the plate, preferably the multiwell plate, comprises at least one cavity with two open ends.

In a preferred embodiment of the present invention, the foil provided in step b) is a membrane. Preferably, the foil, in particular the membrane, provided in step b) comprises at least one foil area, in particular at least one membrane area, which is smaller than or equal in size as the outer contour of the part of the workpiece to be foiled, in particular as the outer contour of an open end of the at least one cavity, and is larger than the inner contour of the part of the workpiece to be foiled, in particular than the inner contour of the open end of the at least one cavity, wherein the at least one foil area, in particular the at least one membrane area, is delimited by at least one punching.

According to a particularly preferred embodiment, each of the foil areas, in particular membrane areas, has a separate punching. According to this preferred embodiment of the present invention, the individual foil areas, in particular membrane areas, do not have a common punching. Preferably, the individual foil areas, in particular membrane areas, and the punchings which delimit the individual foil areas, in particular membrane areas, are spaced apart from one another in the foil, in particular in the membrane. Particularly preferred, the individual foil areas, in particular membrane areas, and the punchings in the foil, in particular in the membrane, which delimit the individual foil areas, in particular membrane areas, are not directly adjacent to one another.

In a preferred embodiment of the present invention, the individual foil areas, in particular membrane areas, and the punchings delimiting the individual foil areas, in particular membrane area, are spaced apart from one another by at least 0.5 mm, preferably at least 1 mm, preferably at least 1.5 mm, preferably, at least 1 mm, preferably at least 1.5 mm, preferably at least 2 mm, preferably at least 2.5 mm, preferably at least 3 mm, preferably at least 3.5 mm, preferably at least 4 mm, preferably at least 4.5 mm, preferably at least 5 mm.

In a preferred embodiment of the present invention, the distance between the outer contour of the part of the workpiece to be foiled, in particular the outer contour of an open end of the at least one cavity, and the inner contour of the part of the workpiece to be foiled, in particular the inner contour of the open end of the at least one cavity, is at most 20 mm, preferably at most 15 mm, preferably at most 10 mm, preferably at most 9 mm, preferably at most 8 mm, preferably at most 7 mm, preferably at most 6 mm, preferably at most 5 mm, preferably at most 4 mm, preferably at most 3 mm, preferably at most 2 mm, preferably at most 1 mm.

In a preferred embodiment of the present invention, the distance between the outer contour of the part of the workpiece to be foiled, in particular the outer contour of an open end of the at least one cavity, and the inner contour of the part of the workpiece to be foiled, in particular the inner contour of the open end of the at least one cavity, is at least 0.5 mm, preferably at least 0.75 mm, preferably at least 1 mm, preferably at least 1.5 mm, preferably at least 2 mm, preferably at least 2.5 mm, preferably at least 3 mm, preferably at least 3.5 mm, preferably at least 4 mm, preferably at least 4.5 mm, preferably at least 5 mm.

In a further preferred embodiment of the present invention, the distance between the outer contour of the part of the workpiece to be foiled, in particular the outer contour of an open end of the at least one cavity, and the inner contour of the part of the workpiece to be foiled, in particular the inner contour of the open end of the at least one cavity, is 0.5 mm to 20 mm, preferably 0.5 mm to 10 mm, preferably 0.75 mm to 5 mm, preferably 0.75 mm to 2.5 mm, preferably 1 mm to 5 mm, preferably 1 mm to 2 mm.

According to a preferred embodiment, the part of the workpiece to be foiled is an open end of at least one cavity of the workpiece, in particular an open end of at least one cavity of a plate, preferably of a multiwell plate. Preferably, in step c) of the method according to the invention, the open end of the at least one cavity of the workpiece, in particular of the plate, preferably of the multiwell plate, is brought into contact with the foil, in particular with the membrane, such that the at least one foil area, in particular the at least one membrane area, comes into congruence with the open end of the at least one cavity.

According to a preferred embodiment of the present invention, it may be provided that in step d) the contacting of the stamp with the foil, in particular with the membrane, takes place such that the at least one foil area, in particular the at least one membrane area, bonds with the workpiece, in particular with a plate, preferably with a multiwell plate, and seal an open end of at least one cavity of the workpiece, in particular of the plate, preferably of the multiwell plate, wherein the stamp has a temperature which is above the glass transition temperature of the first and/or second material.

In a preferred embodiment, the heated stamp is removed in step e) of the method according to the invention to obtain a foiled workpiece, in particular a membrane bottom plate.

According to a particularly preferred embodiment of the present invention, the method for producing a foiled workpiece is a method for producing a membrane bottom plate, comprising the steps of:
a) providing a workpiece, in particular a plate, preferably a multiwell plate, made of a first material, comprising at least one cavity with two open ends,
b) providing a foil, in particular a membrane, made of a second material, wherein the foil, in particular the membrane, has at least one foil area, in particular at least one membrane area, which is smaller than or equal in size as the outer contour of an open end of the at least one cavity and is larger than the inner contour of the open end of the at least one cavity, wherein the at least one foil area, in particular the at least one membrane area, is delimited by at least one punching, and wherein the at least one foil area, in particular the at least one membrane area, is held in the foil, in particular in the membrane, by means of at least one connection,
c) contacting the open end of the at least one cavity with the foil, in particular with the membrane, such that the at least one foil area, in particular the at least one membrane area, comes into congruence with the open end of the at least one cavity,
d) contacting a stamp with the foil, in particular with the membrane, such that the at least one foil area, in particular the at least one membrane area, bonds with the workpiece, in particular with the plate, preferably with the multiwell plate, and seals the open end of the at least one cavity, wherein the stamp has a temperature which is above the glass transition temperature of the first and/or second material, and
e) removing the heated stamp to obtain a foiled workpiece, in particular a membrane bottom plate.

The method according to the present invention advantageously allows efficient and solvent-free and residue-free bonding of a part of a workpiece to be foiled, in particular of a workpiece comprising at least one cavity, in particular of a plate comprising at least one cavity, preferably of a multiwell plate, to a foil, in particular to a membrane, to obtain a foiled workpiece, in particular to obtain a membrane bottom plate. The method is in particular characterized by the fact that the foil provided, in particular the membrane provided, has at least one foil area, in particular at least one membrane area, which is delimited by at least one punching.

In a particularly preferred embodiment of the present invention, in a step a1) which is carried out before step b), preferably before step a) and step b), a punching of a foil, in particular of a membrane takes place, to obtain the foil, in particular membrane, provided in step b), that is, to obtain a foil, in particular a membrane, which has at least one foil area, in particular at least one membrane area which is delimited by at least one punching, wherein the at least one foil area, in particular the at least one membrane area, is held in the foil, in particular in the membrane, by means of at least one connection.

Preferably, the foil, in particular the membrane, is punched in step al) in an apparatus for producing a foiled workpiece according to the invention, in particular in an apparatus for producing a membrane bottom plate according to the present invention.

Particularly preferred, both the punching of the foil, in particular of the membrane, according to step a1) and the contacting of a stamp with the foil, in particular with the membrane, such that the at least one foil area, in particular the at least one membrane area, bonds to the workpiece and seals the part of the workpiece to be foiled according to step d) are carried out in an apparatus for producing a foiled workpiece according to the present invention, in particular in an apparatus for producing a membrane bottom plate according to the present invention.

According to a preferred embodiment of the present invention, steps a), b), c), d) and e), preferably steps a1), a), b), c), d), e), e1) and f), particularly preferably all steps, of the method for producing a foiled workpiece according to the invention, in particular of the method for producing a membrane bottom plate according to the invention, are carried out in an apparatus for producing a foiled workpiece according to the invention, in particular in an apparatus for producing a membrane bottom plate according to the invention.

According to the invention, it can also be provided that the foil, in particular membrane, provided in step b), having at least one foil area, in particular at least one membrane area, which is delimited by at least one punching, is already provided with punching, in particular that no punching of the foil, in particular membrane, takes place in an apparatus for producing a foiled workpiece, in particular for producing a membrane bottom plate, according to the invention. According to this embodiment of the present invention, the punching of the foil, in particular of the membrane, and the bonding of the at least one foil area, in particular the at least one membrane area, to the part of the workpiece to be foiled are carried out in different apparatuses.

Preferably, the at least one foil area, in particular the at least one membrane area, is smaller than or equal in size as the outer contour of a part of the workpiece to be foiled, in particular as the outer contour of an open end of at least one cavity of the workpiece, in particular of the plate, preferably of the multiwell plate, and larger than the inner contour of the part of the workpiece to be foiled, in particular than the inner contour of the open end of the at least one cavity of the workpiece, in particular of the plate, preferably of the multiwell plate.

The at least one punching is carried out in such a way that the at least one foil area, in particular the at least one membrane area, is held in the at least one foil, in particular in the membrane, by means of at least one connection. The at least one connection is subsequently plasticized or rather melted at a temperature which is above the glass transition temperature of the second material of the foil, in particular of the membrane, and/or above the glass transition temperature of the first material of the workpiece, in particular of the plate, preferably of the multiwell plate.

The method according to the invention ensures that the contacting of the part of the workpiece to be foiled provided, in particular the open end of the at least one cavity of the workpiece provided, in particular of the plate provided, preferably of the multiwell plate, with the at least one foil area, in particular with the at least one membrane area, of the foil, in particular of the membrane, and the subsequent contacting of a heated stamp results in a rapid, solvent-free and residue-free thermal bonding of the at least one foil area, in particular of the at least one membrane area, to the part of the workpiece to be foiled, in particular to the open end of the at least one cavity.

By providing a foil, in particular a membrane, with foil areas, in particular membrane areas, which are pre-punched to fit precisely for the part of the workpiece to be foiled, in particular for the corresponding open ends of the cavities, it is also achieved that each foiled part of the workpiece, in particular that each of the cavities of the foiled workpiece, in particular of the membrane bottom plate, has a separate, delimited foil area, in particular membrane area. In the case of membrane bottom plates, a cross-contamination between the individual cavities can, for example, be excluded in this way. By providing a foil, in particular a membrane, with foil areas, in particular membrane areas, which are delimited by at least one punching and which are held in the foil, in particular in the membrane, by means of at least one connection, it is also possible to carry out the process quickly, precisely and cost-effectively. This is in particular because the foil, in particular the membrane, with the pre-punched foil areas, in particular the pre-punched membrane areas, can be used as roll material and because no further step of cutting or punching out the foil, in particular the membrane, is necessary after the thermal bonding of the foil areas, in particular the membrane areas, to the part of the workpiece to be foiled, in particular to the open ends of the cavities. In this way, the risk of contamination from cut-off punching sections and also the risk of the formation of leaks in the welded edge due to tears in the foil, in particular in the membrane, are significantly reduced.

A further advantage of the method according to the invention is that the foil areas, in particular membrane areas, sealing the part of the workpiece to be foiled, in particular the open end of the individual cavities, have a particularly high flatness or rather planarity. In addition, the foiled workpieces obtained by the method according to the invention, in particular the membrane bottom plates obtained by the method according to the invention, are advantageously characterized by a high stability, have a high resistance to simple mechanical stress and are suitable for use over longer periods of time. In the case of membrane bottom plates, in particular for use over longer cultivation periods.

In a preferred embodiment of the present invention, the workpiece provided in step a), in particular the plate provided in step a), preferably the multiwell plate, has at least 2, preferably at least 6, preferably at least 12, preferably at least 24, preferably at least 48, preferably at least 96, preferably at least 384, preferably at least 1536, preferably at least 3456, cavities.

According to a further preferred embodiment of the present invention, the workpiece provided in step a), in particular the plate provided in step a), preferably the multiwell plate, has at most 3456, preferably at most 1536, preferably at most 384, preferably at most 96, preferably at most 48, preferably at most 24, preferably at most 12, preferably at most 6, cavities.

Particularly preferred, the workpiece provided in step a), in particular the plate provided in step a), preferably the multiwell plate, has 2, preferably 6, preferably 12, preferably 24, preferably 48, preferably 96, preferably 384, preferably 1536, preferably 3456, cavities.

According to a particularly preferred embodiment of the present invention, the at least one cavity is at least one cup (well).

According to a preferred embodiment, the foil, in particular the membrane, has at most two layers. In a preferred embodiment of the present invention, the foil, in particular the membrane, is a two-layer foil, in particular a two-layer membrane. In a particularly preferred embodiment, the foil, in particular the membrane, is a single-layer foil, in particular a single-layer membrane.

Preferably, the foil, in particular the membrane, consists of one single material.

According to the invention, it can also be provided that the foil has more than two layers. In this case, an outer layer of the foil facing the workpiece can be an adhesive layer and/or an adhesion-promoting layer. Preferably, a carrier foil can be provided on a side of the foil facing away from the workpiece. Preferably, further layers of the foil can be arranged on the side of the carrier foil facing the workpiece. Alternatively or additionally, further layers of the foil can be arranged on the side of the carrier foil facing away from the workpiece. These layers can, for example, be varnish layers and/or metal layers, each of which can be present entirely or partially in the respective layer plane.

In a further preferred embodiment of the present invention, the foil is a membrane, preferably a filter membrane.

In a preferred embodiment of the present invention, the foil, in particular the membrane, preferably the filter membrane, has a thickness of 5 μm to 1000 μm, preferably 50 μm to 800 μm, preferably 100 μm to 600 μm, preferably 250 μm to 400 μm.

In a further preferred embodiment of the present invention, the foil, in particular the membrane, preferably the filter membrane, has a thickness of 5 μm to 60 μm, preferably 10 μm to 50 μm, preferably 15 μm to 45 μm, preferably 20 μm to 40 μm.

Particularly preferred, the foil, especially the membrane, preferably the filter membrane, has a thickness of at least 5 μm, preferably at least 10 μm, preferably at least 15 μm, preferably at least 20 μm, preferably at least 25 μm, preferably at least 30 μm, preferably at least 35 μm, preferably at least 40 μm, preferably at least 45 μm, preferably at least 50 μm, preferably at least 75 μm, preferably at least 100 μm, preferably at least 200 μm, preferably at least 250 μm, preferably at least 300 μm, preferably at least 400 μm, preferably at least 500 μm.

In a preferred embodiment, the foil, in particular the membrane, preferably the filter membrane, has a thickness of at most 1000 μm, preferably at most 900 μm, preferably at most 800 μm, preferably at most 700 μm, preferably at most 600 μm, preferably at most 500 μm, preferably at most 400 μm, preferably at most 300 μm, preferably at most 250 μm, preferably at most 200 μm, preferably at most 150 μm, preferably at most 100 μm, preferably at most 90 μm, preferably at most 80 μm, preferably at most 70 μm, preferably at most 60 μm, preferably at most 55 μm, preferably at most 50 μm, preferably at most 45 μm, preferably at most 40 μm, preferably at most 35 μm, preferably at most 30 μm.

In particular, the foil, especially the membrane, preferably the filter membrane, has a thickness of 5 μm to 60 μm, preferably 10 μm to 50 μm.

In a particularly preferred embodiment of the present invention, the first material is a plastic. Particularly preferred, the first material is at least one material selected from the group consisting of polyethylene terephthalate (PET), polystyrene (PS), polyvinylidene fluoride (PVDF), and polycarbonate (PC).

In a preferred embodiment of the present invention, the second material is a plastic. In a particularly preferred embodiment, the second material is at least one material selected from the group consisting of polyethylene terephthalate (PET), polystyrene (PS), polyvinylidene fluoride (PVDF), and polycarbonate (PC).

In a preferred embodiment, the first and second materials are the same material.

According to a particularly preferred embodiment of the present invention, the first and/or second material is polycarbonate (PC).

Particularly preferred, the first material is PET and the second material is PS. Preferably, the first material is PET and the second material is PVDF. In a further preferred embodiment, the first material is PET and the second material is PET. Particularly preferred, the first material is PET and the second material is PC.

According to a preferred embodiment of the present invention, the first material is PS and the second material is PET. More preferably, the first material is PS and the second material is PS. In a further preferred embodiment, the first material is PS and the second material is PVDF. Preferably, the first material is PS and the second material is PC.

In a preferred embodiment of the present invention, the first material is PVDF and the second material is PET. Preferably, the first material is PVDF and the second material is PS. According to a further embodiment, the first material is PVDF and the second material is PVDF. Preferably, the first material is PVDF and the second material is PC.

In a further preferred embodiment, the first material is PC and the second material is PET. In a particularly preferred embodiment, the first material is PC and the second material is PS. In a further preferred embodiment, the first material is PC and the second material is PVDF. Particularly preferred, the first material is PC and the second material is PC.

In a further preferred embodiment of the present invention, the at least one foil area, in particular the at least one membrane area, is held in the foil, in particular in the membrane, by at least two, preferably exactly two, connections. Preferably, the at least one foil area, in particular the at least one membrane area, is held in the foil, in particular in the membrane, by at least three, preferably exactly three, connections. In a further preferred embodiment, the at least one foil area, in particular the at least one membrane area, is held in the foil, in particular in the membrane, by at least four, preferably exactly four, connections. In a particularly preferred embodiment, in each case two connections are located opposite each other.

In a particularly preferred embodiment of the present invention, the at least one connection is at least one web.

Preferably, the at least one web has a width of at least 0.05 mm, preferably at least 0.1 mm, preferably at least 0.15 mm, preferably at least 0.2 mm, preferably at least 0.25 mm, preferably at least 0.3 mm, preferably at least 0.35 mm, preferably at least 0.4 mm, preferably at least 0.4 mm, preferably at least 0.45 mm, preferably at least 0.5 mm.

In a further preferred embodiment, the at least one web has a width of at most 2 mm, preferably at most 1.75 mm, preferably at most 1.5 mm, preferably at most 1.25 mm, preferably at most 1 mm, preferably at most 0.75 mm, preferably at most 0.5 mm, preferably at most 0.45 mm, preferably at most 0.4 mm, preferably at most 0.35 mm, preferably at most 0.3 mm, preferably at most 0.25 mm, preferably at most 0.2 mm, preferably at most 0.15 mm, preferably at most 0.1 mm, preferably at most 0.05 mm.

Particularly preferred, the at least one web has a width of 0.05 mm to 2 mm, preferably 0.05 mm to 1.5 mm, preferably 0.1 mm to 1 mm, preferably 0.15 mm to 0.75 mm, preferably 0.15 mm to 0.5 mm, preferably 0.15 mm to 0.4 mm, preferably 0.15 mm to 0.3 mm, preferably 0.15 mm to 0.25 mm.

In a preferred embodiment of the present invention, the at least one web has a length of at least 0.1 mm, preferably at least 0.2 mm, preferably at least 0.3 mm, preferably at least 0.4 mm, preferably at least 0.5 mm, preferably at least 0.6 mm, preferably at least 0.7 mm, preferably at least 0.8 mm, preferably at least 0.9 mm, preferably at least 1 mm, preferably at least 1.25 mm, preferably at least 1.5 mm, preferably at least 1.75 mm, preferably at least 2 mm, preferably at least 2.25 mm, preferably at least 2.5 mm, preferably at least 2.75 mm, preferably at least 3 mm.

In a further preferred embodiment, the at least one web has a length of at most 5 mm, preferably at most 4 mm, preferably at most 3 mm, preferably at most 2.75 mm, preferably at most 2.5 mm, preferably at most 2.25 mm, preferably at most 2 mm, preferably at most 1.75 mm, preferably at most 1.5 mm, preferably at most 1.25 mm, preferably at most 1 mm, preferably at most 0.75 mm, preferably at most 0.5 mm, preferably at most 0.25 mm, preferably at most 0.1 mm.

Particularly preferred, the at least one web has a length of 0.1 mm to 5 mm, preferably 0.5 mm to 5 mm, preferably 0.75 mm to 5 mm, preferably 1 mm to 4 mm, preferably 1 mm to 3.5 mm, preferably 1.5 mm to 3 mm, preferably 1.5 mm to 2.75 mm, preferably 1.5 mm to 2.5 mm.

According to a preferred embodiment of the present invention, the at least one part of the workpiece to be foiled, in particular the at least one cavity, preferably the at least one open end of the at least one cavity, has a round, rectangular, in particular square, or polygonal cross-section.

In a particularly preferred embodiment of the present invention, the foil, in particular the membrane, has a number of foil areas, in particular membrane areas, corresponding to the number of the parts of the workpiece to be foiled, in particular the cavities. Particularly preferably, the foil areas, in particular the membrane areas, are each smaller than or equal in size as the outer contour of the part of the workpiece to be foiled, in particular as the outer contour of the open end of the cavities, and larger than the inner contour of the part of the workpiece to be foiled, in particular than the inner contour of the open end of the cavities, wherein the foil areas, in particular the membrane areas, are each delimited by a punching.

In a preferred embodiment of the present invention, the stamp in step d) has a temperature which is at most 5 °C, preferably at most 10 °C, preferably at most 15 °C, preferably at most 20 °C, preferably at most 25 °C, preferably at most 30 °C, preferably at most 40 °C, preferably at most 50 °C, above the glass transition temperature of the first and/or second material, in particular above the glass transition temperature of the material with the lower glass transition temperature.

According to a preferred embodiment of the present invention, the stamp in step d) has a temperature which at least is 5 °C, preferably at least 10 °C, preferably at least 15 °C, preferably at least 20 °C, preferably at least 25 °C, preferably at least 30 °C, above the glass transition temperature of the first and/or second material, in particular above the glass transition temperature of the material with the lower glass transition temperature.

Preferably, the stamp is brought into contact with the foil, in particular with the membrane, in step d) at a temperature which is at most 5 °C, preferably at most 10 °C, preferably at most 15 °C, preferably at most 20 °C, preferably at most 25 °C, preferably at most 30 °C, preferably at most 40 °C, preferably at most 50 °C, above the glass transition temperature of the first and/or second material, in particular above the glass transition temperature of the material with the lower glass transition temperature.

Particularly preferred, the contacting of the stamp with the foil, in particular with the membrane, in step d) takes place at a temperature which at least 5 °C, preferably at least 10 °C, preferably at least 15 °C, preferably at least 20 °C, preferably at least 30 °C, above the glass transition temperature of the first and/or second material, in particular above the glass transition temperature of the material with the lower glass transition temperature.

According to a further preferred embodiment the contacting of the stamp with the foil, in particular with the membrane, in step d) takes place at a temperature of 120 °C to 180 °C, preferably 125 °C to 175 °C, preferably 130 °C to 170 °C, preferably 135 °C to 165 °C, particularly preferably 140 °C to 160 °C.

In a further preferred embodiment of the present invention, the contacting of the stamp with the foil, in particular with the membrane, in step d) takes place at a temperature of at least 120 °C, preferably at least 125 °C, preferably at least 130 °C, preferably at least 135 °C, preferably at least 140 °C, preferably at least 145 °C, preferably at least 150 °C, preferably at least 155 °C, preferably at least 160 °C, preferably at least 165 °C, preferably at least 170 °C, preferably at least 175 °C, preferably at least 180 °C.

In a preferred embodiment of the present invention, the contacting of the stamp with the foil, in particular with the membrane, in step d) takes place at a temperature of at most 200 °C, preferably at most 195 °C, preferably at most 190 °C, preferably at most 185 °C, preferably at most 180 °C, preferably at most 175 °C, preferably at most 170 °C, preferably at most 165 °C, preferably at most 160 °C.

Preferably, the contacting of the stamp with the foil, in particular with the membrane, in step d) takes place for a time of 0.1 to 5 seconds, preferably 0.25 to 4 seconds, preferably 0.5 to 3 seconds, preferably 0.75 to 2.5 seconds, particularly preferably 1 to 2 seconds.

Particularly preferred, the contacting of the stamp with the foil, in particular with the membrane, in step d) takes place for a time of at most 5 seconds, preferably at most 4 seconds, preferably at most 3 seconds, particularly preferably at most 2 seconds.

According to a preferred embodiment of the present invention, the contacting of the stamp with the foil, in particular with the membrane, in step d) takes place at a temperature of 120 °C to 180 °C and for a time of at most 4 seconds.

In a further preferred embodiment of the present invention, the contacting of the stamp with the foil, in particular with the membrane, in step d) takes place for a time of at least 0.1 seconds, preferably at least 0.25 seconds, preferably at least 0.5 seconds, preferably at least 0.75 seconds, preferably at least 1 second, preferably at least 1.25 seconds, preferably at least 1.5 seconds, preferably at least 1.75 seconds, preferably at least 2 seconds, preferably at least 2.5 seconds, preferably at least 3 seconds.

In a preferred embodiment, the contacting of the stamp with the foil, in particular with the membrane, in step d) takes place with a force of 0.25 kN to 25 kN, preferably 0.5 kN to 20 kN, preferably 0.75 kN to 15 kN, preferably 1 kN to 10 kN, preferably 1.25 kN to 7.5 kN, preferably 1.5 kN to 5 kN, preferably 1.75 kN to 4.5 kN, preferably 2 kN to 4 kN, particularly preferably 2.5 kN to 3.5 kN.

According to a further preferred embodiment of the present invention, the contacting of the stamp with the foil, in particular with the membrane, in step d) takes place with a force of at least 0.25 kN, preferably at least 0.5 kN, preferably at least 1 kN, preferably at least 1.5 kN, preferably at least 2 kN, preferably at least 2.5 kN, preferably at least 3 kN, preferably at least 3.5 kN, preferably at least 4 kN, preferably at least 4.5 kN, preferably at least 5 kN, preferably at least 7.5 kN, preferably at least 10 kN, preferably at least 15 kN.

Preferably, the contacting of the stamp with the foil, in particular with the membrane, in step d) takes place with a force of at most 30 kN, preferably at most 25 kN, preferably at most 20 kN, preferably at most 17.5 kN, preferably at most 15 kN, preferably at most 12.5 kN, preferably at most 10 kN, preferably at most 7.5 kN, preferably at most 5 kN, preferably at most 4 kN, preferably at most 3 kN, preferably at most 2 kN.

In a further preferred embodiment of the present invention, the contacting of the stamp with the foil, in particular with the membrane, in step d) takes place at a temperature of 140 to 160 °C, preferably 145 to 155 °C, particularly preferably 150 °C, for a time of 0.5 to 2.5 seconds, preferably 1 to 2 seconds, particularly preferably 1.25 to 1.75 seconds, and with a force of 1 to 6 kN, preferably 2 to 5 kN, particularly preferably 3 to 4 kN. In a preferred embodiment, it may be provided that the workpiece, in particular the membrane bottom plate, is cooled, in particular passively cooled, in a step e1) following step e), for a duration of 1 to 8 seconds, preferably 2 to 6 seconds, particularly preferably 3 to 5 seconds.

Under the aforementioned conditions, a particularly high flatness, in particular a particularly low flatness tolerance, of the foil area, in particular membrane area, sealing the at least one part of the workpiece to be foiled and having a thickness of 25 μm, could be observed. The combination of the hot stamping parameters results in the parts of the workpiece to be foiled being sealed efficiently, tightly, and particularly flat without damage, in particular without deformation of the workpiece to be foiled itself, due to excessive temperature, excessive stamping time and/or excessive stamping force, and/or of the foil area, in particular membrane area, on the part of the workpiece to be foiled. A person skilled in the art is aware that the choice of the hot stamping parameters depends on the material of the workpiece, on the material of the foil, in particular of the membrane, and on the thickness of the foil, in particular of the membrane, and that the parameters must therefore be adapted to the specific application, accordingly. According to a preferred embodiment of the present invention, the foil, in particular the membrane, is an at least partially porous foil, in particular an at least partially porous membrane.

In a preferred embodiment of the present invention, the foil, in particular the membrane, has an average pore size of 0.05 μm to 15 μm, preferably 0.1 μm to 10 μm, preferably 0.2 μm to 5 μm, preferably 0.3 μm to 4 μm, preferably 0.4 μm to 3 μm, preferably 0.5 μm to 2 μm.

Particularly preferred, the foil, especially the membrane, has an average pore size of at least 0.05 μm, preferably at least 0.075 μm, preferably at least 0.1 μm, preferably at least 0.125 μm, preferably at least 0.15 μm, preferably at least 0.175 μm, preferably at least 0.2 μm, preferably at least 0.225 μm, preferably at least 0.25 μm, preferably at least 0.275 μm, preferably at least 0.3 μm, preferably at least 0.325 μm, preferably at least 0.35 μm, preferably at least 0.375 μm, preferably at least 0.4 μm, preferably at least 0.425 μm, preferably at least 0.45 μm, preferably at least 0.475 μm, preferably at least 0.5 μm.

In a further preferred embodiment of the present invention, the foil, in particular the membrane, has an average pore size of at most 15 μm, preferably at most 14 μm, at most 13 μm, preferably at most 12 μm, preferably at most 11 μm, preferably at most 10 μm, preferably at most 9 μm, preferably at most 8 μm, preferably at most 7 μm, preferably at most 6 μm, preferably at most 5 μm, preferably at most 4 μm, preferably at most 3 μm, preferably at most 2.5 μm, preferably at most 2 μm, preferably at most 1.5 μm, preferably at most 1 μm, preferably at most 0.75 μm, preferably at most 0.5 μm.

In a particularly preferred embodiment of the present invention, the foil, in particular the membrane, is a polycarbonate (PC) membrane with an average pore size of 0.05 μm to 10 μm, preferably 0.1 μm to 5 μm, preferably 0.2 μm to 4 μm, preferably 0.25 μm to 3 μm, preferably 0.3 μm to 2 μm, preferably 0.35 μm to 1 μm, preferably 0.4 μm to 0.8 μm.

Preferably, the foil, in particular the membrane, is a polycarbonate (PC) membrane with an average pore size of 0.05 μm to 15 μm, preferably 0.2 μm to 10 μm.

According to a preferred embodiment of the present invention, the foil, in particular the membrane, has a porosity of at least 5 %, preferably at least 6 %, preferably at least 7 %, preferably at least 8 %, preferably at least 9 %, preferably at least 10 %, preferably at least 11 %, preferably at least 12 %, preferably at least 13 %, preferably at least 14 %, preferably at least 15 %.

In a further preferred embodiment of the present invention, the foil, in particular the membrane, has a porosity of at most 30 %, preferably at most 25 %, preferably at most 20 %, preferably at most 19 %, preferably at most 18 %, preferably at most 17 %, preferably at most 16 %, preferably at most 15 %, preferably at most 14 %, preferably at most 13 %, preferably at most 12 %, preferably at most 11 %, preferably at most 10 %.

Particularly preferred, the foil, in particular the membrane, has a porosity of 5 to 30 %, preferably 6 to 25 %, preferably 7 to 20 %, preferably 8 to 18 %, preferably 10 to 16 %, preferably 12 to 14 %.

According to a preferred embodiment, the foil, in particular the membrane, is transparent. Preferably, the foil, in particular the membrane, is translucent. According to a further embodiment of the present invention, the foil, in particular the membrane, is opaque. The transparency and/or translucency and/or opacity can also be present in the foil only in certain areas, i.e. partially, while other areas of the foil have a transparency and/or translucency and/or opacity that differs from this area.

According to the invention, it may be provided that the foil, in particular the membrane, is non-permeable. In a particularly preferred embodiment of the present invention, the foil, in particular the membrane, is permeable, in particular mono-or unidirectionally permeable. More preferably, the foil, in particular the membrane, is omnipermeable, semi-permeable, or selectively permeable.

According to a preferred embodiment of the present invention, the foil, in particular the membrane, is a filter membrane. In a particularly preferred embodiment, the foiled workpiece is a membrane bottom plate, in particular a filter plate.

In a preferred embodiment of the present invention, the workpiece, in particular the membrane bottom plate, is cooled, in particular passively cooled, in a step e1) following step e). Preferably, the cooling, in particular the passive cooling, in step e1) takes place for a duration of at least 2 seconds, preferably at least 3 seconds, preferably at least 4 seconds, preferably at least 5 seconds, preferably at least 6 seconds. According to a preferred embodiment, the cooling, in particular the passive cooling, in step e1) takes place for a duration of at most 30 seconds, preferably at most 25 seconds, preferably at most 20 seconds, preferably at most 15 seconds, preferably at most 10 seconds.

In a preferred embodiment of the present invention, the separation of at least one foil area, in particular membrane area, which is bonded to the workpiece, in particular to the membrane bottom plate, and seals the at least one part of the workpiece to be foiled, in particular the open end of the at least one cavity of the workpiece, in particular of the membrane bottom plate, from the foil, in particular from the membrane, takes place in a step f) following step e) or el). Particularly preferred, the separation of at least one foil area, in particular membrane area, which is bonded to the workpiece, in particular to the plate, and seals the at least one part of the workpiece to be foiled, in particular the open end of the at least one cavity of the workpiece, in particular of the membrane bottom plate, from the foil, in particular from the membrane, in a step f) takes place by moving the workpiece, in particular the membrane bottom plate, relative to the foil, in particular relative to the membrane, that is, the workpiece, in particular the membrane bottom plate, is moved away from the foil, in particular from the membrane.

Alternatively, it may also be provided according to the invention that the separation of the at least one foil area, in particular membrane area, which is bonded to the workpiece, in particular to the plate, and seals the at least one part of the workpiece to be foiled, in particular the open end of the at least one cavity of the workpiece, in particular of the membrane bottom plate, from the foil, in particular from the membrane, in step f) takes place by a movement of the foil, in particular of the membrane, relative to the workpiece, in particular relative to the membrane bottom plate, that is, the foil, in particular the membrane, is moved away from the workpiece, in particular from the membrane bottom plate, preferably is pulled off.

In a further embodiment of the present invention, the separation of the at least one foil area, in particular membrane area, which is bonded to the workpiece, in particular to the plate, and seals the at least one part of the workpiece to be foiled, in particular the open end of the at least one cavity of the workpiece, in particular of the membrane bottom plate, from the foil, in particular from the membrane, in step f) takes place by a movement of the workpiece, in particular of the membrane bottom plate, and of the foil, in particular of the membrane, that is, both the workpiece, in particular the membrane bottom plate, and the foil, in particular the membrane, are moved relative to one another, in particular the workpiece, in particular the membrane bottom plate, and the foil, in particular the membrane, are moved away from one another.

In a particularly preferred embodiment of the present invention, the separation of the at least one foil area, in particular membrane area, which is bonded to the workpiece, in particular to the plate, and seals the at least one part of the workpiece to be foiled, in particular the open end of the at least one cavity of the workpiece, in particular of the membrane bottom plate, from the foil, in particular from the membrane, in step f) takes place by a separation member. In particular, the separation member can be moved horizontally and/or vertically. During sealing, the separation member is arranged between the workpiece and the stamp. In particular, the separation member is arranged directly adjacent to or under the foil web, preferably at a distance of 0 mm to 10 mm from the foil web. Particularly preferred, the separation member serves to lift and/or detach the foil web in step f) from the workpiece in a controlled manner. For this purpose, the separation member is particularly rigidly shaped and made of materials, which are individually or in combination or as a hybrid material selected from: metal, plastic, wood materials, fiber materials. The separation member preferably has a thickness of 0.1 mm to 10 mm in order to achieve the bending stiffness depending on the material or material combination used.

If the at least one connection, in particular the at least one web, by which the at least one foil area, in particular the at least one membrane area, is held in the foil, in particular in the membrane, has not yet been melted in step d), then the at least one connection, in particular the at least one web, is torn off in step f) by moving away the workpiece, in particular the membrane bottom plate, with the at least one foil area, in particular membrane area, which is bonded to the part of the workpiece to be foiled, in particular to the open end of the at least one cavity of the workpiece, in particular of the membrane bottom plate, and the foil, in particular the membrane, form one another.

The present invention also relates to a foiled workpiece, in particular a membrane bottom plate, producible, in particular produced, by the method according to the invention.

The foiled workpieces, in particular membrane bottom plates, producible, in particular produced, by the method according to the invention are advantageously in particular characterized in that the foil areas, in particular the membrane areas, of the foiled parts of the workpiece, in particular the foil areas, in particular membrane areas, forming the bottom of the at least one cavity of the workpiece, in particular of the membrane bottom plates, are particularly flat, in particular particularly planar.

In a preferred embodiment of the present invention, the foil area, in particular the membrane area, sealing the at least one part of the workpiece to be foiled, in particular the open end of the at least one cavity of the workpiece, in particular of the membrane bottom plate, has a flatness tolerance of at most 200 μm, preferably at most 190 μm, preferably at most 180 μm, preferably at most 170 μm, preferably at most 160 μm, preferably at most 150 μm, preferably at most 140 μm, preferably at most 130 μm, preferably at most 120 μm, preferably at most 110 μm, preferably at most 100 μm, preferably at most 90 μm, preferably at most 80 μm, preferably at most 70 μm, preferably at most 60 μm, preferably at most 50 μm.

Particularly preferred, the foil area, in particular the membrane area, sealing the at least one part of the workpiece to be foiled, in particular the open end of the at least one cavity of the workpiece, in particular of the membrane bottom plate, has a flatness tolerance of 5 μm to 200 μm, preferably 10 μm to 190 μm, preferably 15 μm to 180 μm, preferably 20 μm to 170 μm, preferably 25 μm to 160 μm, preferably at most 30 μm to 150 μm, preferably 35 μm to 140 μm, preferably 40 μm to 130 μm, preferably 45 μm to 120 μm, preferably 50 μm to 100 μm, preferably 55 μm to 100 μm, preferably 60 μm to 100 μm.

In a further preferred embodiment of the present invention, the workpiece, in particular the membrane bottom plate, has at least two cavities, each of which having one open end which is sealed by a foil area, in particular membrane area, wherein the flatness tolerance for each of the foil areas, in particular membrane areas, sealing the at least two cavities is at most 200 μm, preferably at most 190 μm, preferably at most 180 μm, preferably at most 170 μm, preferably at most 160 μm, preferably at most 150 μm, preferably at most 140 μm, preferably at most 130 μm, preferably at most 120 μm, preferably at most 110 μm, preferably at most 100 μm, preferably at most 90 μm, preferably at most 80 μm, preferably at most 70 μm, preferably at most 60 μm, preferably at most 50 μm.

According to a preferred embodiment of the present invention, the workpiece, in particular the membrane bottom plate, has at least two cavities, each of which having one open end which is sealed by a foil area, in particular membrane area, wherein the flatness tolerance for each of the foil areas, in particular membrane areas, sealing the at least two cavities is in the range from 5 μm to 200 μm, preferably 10 μm to 190 μm, preferably 15 μm to 180 μm, preferably 20 μm to 170 μm, preferably 25 μm to 160 μm, preferably 30 μm to 150 μm, preferably 35 μm to 140 μm, preferably 40 μm to 130 μm, preferably 45 μm to 120 μm, preferably 50 μm to 100 μm, preferably 55 μm to 100 μm, preferably 60 μm to 100 μm.

In a preferred embodiment, it may also be provided that the workpiece, in particular the membrane bottom plate, has at least two cavities, each of which having one open end which is sealed by a foil area, in particular membrane area, wherein the flatness tolerance averaged from the flatness tolerances of all foil areas, in particular membrane areas, of the workpiece, in particular membrane bottom plate, is at most 200 μm, preferably at most 190 μm, preferably at most 180 μm, preferably at most 170 μm, preferably at most 160 μm, preferably at most 150 μm, preferably at most 140 μm, preferably at most 130 μm, preferably at most 120 μm, preferably at most 110 μm, preferably at most 100 μm, preferably at most 90 μm, preferably at most 80 μm, preferably at most 70 μm, preferably at most 60 μm, preferably at most 50 μm.

Particularly preferred, the workpiece, in particular the membrane bottom plate, has at least two cavities, each of which having one open end which is sealed by a foil area, in particular membrane area, wherein the flatness tolerance averaged from the flatness tolerances of all foil areas, in particular membrane areas, of the workpiece, in particular membrane bottom plate, is in the range from 5 μm to 200 μm, preferably 10 μm to 190 μm, preferably 15 μm to 180 μm, preferably 20 μm to 170 μm, preferably 25 μm to 160 μm, preferably at most 30 μm to 150 μm, preferably 35 μm to 140 μm, preferably 40 μm to 130 μm, preferably 45 μm to 120 μm, preferably 50 μm to 100 μm, preferably 55 μm to 100 μm, preferably 60 μm to 100 μm.

In a further preferred embodiment of the present invention, the foil area, in particular the membrane area, sealing the at least one part of the workpiece to be foiled, in particular the open end of the at least one cavity of the workpiece, in particular the membrane bottom plate, has no overhang. In particular, the workpieces, in particular the membrane bottom plates, according to the invention are advantageously characterized in that the foil area, in particular membrane area, sealing the at least one part of the workpiece to be foiled, in particular the open end of the at least one cavity, does not protrude beyond the outer contour of the part to be foiled, in particular beyond the outer contour of an open end of the at least one cavity. This means that the foil, in particular the membrane, has a foil area, in particular a membrane area, which is smaller than or equal in size as the outer contour of the at least one part of the workpiece to be foiled, in particular as the outer contour of the open end of the cavity to be sealed.

A further aspect of the present invention relates to a system comprising at least one foiled workpiece. Particularly preferred, the system is a membrane bottom plate system, comprising a membrane bottom plate according to the invention, a receiver plate and a lid.

According to a preferred embodiment of the present invention, the system according to the invention is a filter plate system, comprising a filter plate, a receiver plate and a lid.

In a preferred embodiment of the present invention, the receiver plate has a number of cavities which corresponds to the number of cavities of the membrane bottom plate, preferably of the filter plate, according to the invention. The individual cavities of the receiver plate are arranged in such a way that in each case a cavity of the membrane bottom plate, preferably of the filter plate, extends into the cavity of the receiver plate, when membrane bottom plate system, preferably filter plate system, is in the assembled state. In particular, it may be provided that the individual cavities of the receiver plate are arranged such that in the assembled state of the membrane bottom plate system, preferably of the filter plate system, in each case a cavity of the membrane bottom plate, preferably of the filter plate, extends into the cavity of the receiver plate without the membranes of the membrane bottom plate, preferably of the filter plate, touching the bottom of the cavities of the receiver plate.

According to a preferred embodiment of the present invention, the individual cavities of the receiver plate serve as liquid reservoirs and enable material exchange between the membrane bottom plate and the liquid in the cavities of the receiver plate.

In a preferred embodiment of the present invention, the individual wells of the receiver plate serve as liquid reservoirs to receive a filtrate or eluate of the membrane bottom plate, preferably of the filter plate.

In a further preferred embodiment, it may be provided that the receiver plate has a number of cavities which differs from the number of cavities of the membrane bottom plate, preferably of the filter plate. For example, it may be provided that the receiver plate has only one cavity which serves to receive a filtrate or eluate of the membrane bottom plate, preferably filter plate.

According to a preferred embodiment of the present invention, the material of the receiver plate is a plastic. Preferably, the material of the lid is a plastic. Particularly preferred, the material of the receiver plate and/or of the lid is at least one material selected from the group consisting of polystyrene (PS), polycarbonate (PC), polypropylene (PP), polyethylene terephthalate (PET) and cycloolefin (COC).

The present invention also relates to an apparatus for producing a foiled workpiece, in particular a membrane bottom plate, preferably an apparatus for carrying out the method according to the invention.

The apparatus for producing a foiled workpiece according to the invention comprises:
i) at least one lower punching tool and at least one upper punching tool,
ii) at least one foil,
iii) at least one stamp,
iv) at least one holding device for holding a workpiece to be foiled,
   wherein the upper punching tool and the stamp are each arranged vertically movable upwards and downwards on a horizontally movable common carrier,
   wherein the lower punching tool can be moved vertically upwards and downwards, and
   wherein the holding device can be moved vertically upwards and can be brought into a position above the lower punching tool and below the foil and the stamp with a workpiece to be foiled arranged therein.

According to a particularly preferred embodiment of the present invention, the following steps are carried out in the apparatus for producing a foiled workpiece according to the invention, in particular in the apparatus for producing a membrane bottom plate, particularly preferred in the apparatus for carrying out the method according to the invention. In particular, the method according to the invention which can be carried out, preferably is carried out, in an apparatus for producing a foiled workpiece according to the invention, in particular in an apparatus for producing a membrane bottom plate, comprising the following substeps:
i. Moving the lower punching tool vertically upwards below the foil, in particular below the foil of a foil web,
ii. Moving the upper punching tool vertically downwards and pressing the upper punching tool against the lower punching tool such that the upper punching tool and the lower punching tool are in a closed state and the foil between the upper punching tool and the lower punching tool is punched,
iii. Moving the lower punching tool vertically downwards and moving the upper punching tool vertically upwards such that the punched foil, in particular the punched foil of the foil web, is released,
iv. Moving the stamp horizontally into a position above a workpiece arranged in the holding device, such that the punched foil, in particular the punched foil of the foil web, is located between the stamp and the workpiece,
v. Moving the holding device with the workpiece vertically upwards,
vi. Moving the stamp vertically downwards onto the workpiece arranged in the holding device such that the punched foil is sealed onto the workpiece,
vii. Moving the holding device vertically downwards and moving the stamp vertically upwards,
viii. Removing the foiled workpiece from the holding device.

Preferably, after step c) and before step d), the workpiece is introduced into the holding device at the same position previously occupied by the lower punching tool. The introduction of the workpiece into the holding device is carried out in a vertical position between the lower punching tool and the foil, such that the lower punching tool is arranged below the holding device with the workpiece.

It is preferable if the upper punching tool and the stamp can each be moved, in particular independently of each other, vertically upwards and downwards, and can be moved horizontally together, in particular can be moved horizontally on a common carrier.

The upper punching tool and the stamp are preferably arranged together on the horizontally movable carrier in a fixed position relative to each other.

The upper punching tool and/or the stamp, in particular on the common carrier, are preferably moved vertically and/or horizontally by means of servomotors.

Separate servomotors are preferably provided for the upper punching tool and stamp for independent vertical movement of the upper punching tool and stamp.

A common servomotor is preferably provided for a joint horizontal movement of the upper punching tool and stamp. The horizontal position of the upper punching tool and/or the horizontal position of the stamp, in particular the horizontal position of the common carrier or rather the horizontal position of the upper punching tool and the horizontal position of the stamp on the common carrier, is preferably controlled with an accuracy of +/−0.1 mm, more preferably of +/-0.01 mm, particularly preferred of +/−0.001 mm.

Accordingly, the apparatus according to the invention enables the punching of a foil and the subsequent sealing of the punched foil onto a workpiece to be foiled.

Particularly preferred, the punching of the foil between the lower punching tool and the upper punching tool and the sealing of the foil onto a workpiece to be foiled which is arranged in the holding device takes place at the same horizontal position in the apparatus according to the invention.

In a preferred embodiment of the apparatus for producing a foiled workpiece, in particular a membrane bottom plate, according to the invention, the foil is in the form of a foil web. Preferably, the apparatus according to the invention comprises at least one foil web, at least one foil unwinding unit and at least one foil rewinding unit. Particularly preferably, the foil unwinding unit and/or the foil rewinding unit comprises a dancer assembly. In a preferred embodiment, the at least one foil web is formed between the foil unwinding unit and foil rewinding unit of the apparatus according to the invention. By means of the foil unwinding unit and the foil rewinding unit, the foil, in particular the membrane, can be unwound from a supply roll in a feed direction and can be rewound as foil residue, in particular membrane residue, after processing. The foil unwinding unit and/or the foil rewinding unit preferably have a dancer assembly to regulate the tension of the foil, in particular of the membrane.

The foil, in particular the membrane, is preferably guided between the foil unwinding unit and the foil rewinding unit in the form of a foil web above a working area and is preferably transported servo-motor driven, in particular by means of a servo-motorized gripper feed, in order to achieve a horizontal transport of the foil, in particular of the membrane, with precise positioning. The position of the foil, in particular of the membrane, during transportation of the foil, in particular of the membrane, is preferably controlled with an accuracy of +/−0.1 mm, preferably of +/−0.01 mm, particularly preferred of +/−0.001 mm. The gripper feed has at least one pincer, which can preferably be opened and closed pneumatically or servo-motor driven. The pincers are preferably formed to grab the edges of the foil web in such a way that the central area of the foil, in particular the membrane, is not damaged. In particular, the gripper feed is arranged upstream of the working area and/or downstream of the working area in the course of the foil web.

Particularly preferred, the at least one foil web is a membrane web.

According to a preferred embodiment of the present invention, the apparatus further comprises an electrostatic unit. The electrostatic unit is used for electrostatically discharging the foil, in particular the membrane, and removes electrostatic charges on the foil, in particular on the membrane, preferably by means of ionization.

In a particularly preferred embodiment of the present invention, the apparatus for producing a foiled workpiece, in particular a membrane bottom plate, according to the invention has a separation member. Preferably, the separation member can be moved horizontally and/or vertically. During sealing, the separation member is arranged between the workpiece and the stamp, in particular on the side of the foil facing away from the stamp and the side of the foil facing the workpiece, that is between the workpiece and the foil. Particularly preferred, the separation member serves to lift and/or detach the foil web from the workpiece in a controlled manner after sealing and during lowering of the workpiece and the holding device in the vertical direction.

In a preferred embodiment of the present invention, the stamp is a silicone stamp.

In a preferred embodiment, the apparatus according to the invention further comprises a counter-pressure element. Preferably, the counter-pressure element is arranged below the holding device for receiving a workpiece to be foiled, in particular is arranged horizontally and vertically movable below the holding device for receiving a workpiece to be foiled.

According to the invention, the apparatus comprises a holding device for receiving at least one workpiece, in particular at least one plate. In a preferred embodiment, the holding device has a manually operable drawer. Preferably, in this way the workpiece and the holding device can be manually introduced into the working area of the apparatus. In a further embodiment of the invention, it may be provided that the holding device is introduced to the working area in an automated manner, in particular by means of a robot system or by other means.

According to the invention, the upper punching tool and the stamp are each, in particular independently from one another, arranged to move vertically upwards and downwards on a horizontally movable common carrier. Preferably, the upper punching tool and the stamp are jointly mounted above the foil, in particular above the membrane, in a fixed position relative to one another in such a way that the upper punching tool and the stamp can jointly be moved horizontally and can each separately, that means independently of one another, be moved vertically. Particularly preferred, the upper punching tool and the stamp are jointly arranged in a fixed position relative to each other on a horizontally movable carrier. The vertical and/or horizontal movement of the upper punching tool and/or of the stamp, in particular on the common carrier, is preferably carried out by means of servomotors. The horizontal position of the upper punching tool and/or the stamp, in particular on the common carrier, is preferably controlled with an accuracy of +/−0.1 mm, preferably of +/−0.01 mm, particularly preferred of +/−0.001 mm.

Particularly preferred, at least the lower punching tool and the workpiece in the holding device are arranged with respect to one another in such a way that the punching of the foil, in particular of the membrane, between the upper punching tool and the lower punching tool and the subsequent sealing of the pre-punched foil, in particular of the pre-punched membrane, onto the workpiece can take place at the same horizontal position in the working area of the apparatus with a very high positional accuracy. Preferably, each of the upper punching tool, the lower punching tool, the holding device with the workpiece, the stamp, and the optional counter-pressure element as well as the optional separation member are then moving to this exact horizontal position. This means that the punching of the foil, in particular of the membrane, as well as the sealing of the pre-punched foil, in particular of the pre-punched membrane, are particularly preferred carried out at the same position, in particular at the same horizontal position, in the working area of the apparatus according to the invention. The foil is only fed in before the punching process begins and is discharged again, preferably by means of a foil unwinding unit and a foil rewinding unit of the apparatus, after the sealing and removing processes have been completed. There is preferably no horizontal movement of the foil, in particular of the membrane, between the start of the punching process and the end of the sealing and removing processes such that the foil, in particular the membrane, can be processed in the working area in a fixed, precisely positioned manner.

The present invention is illustrated below by means of figures and an example.

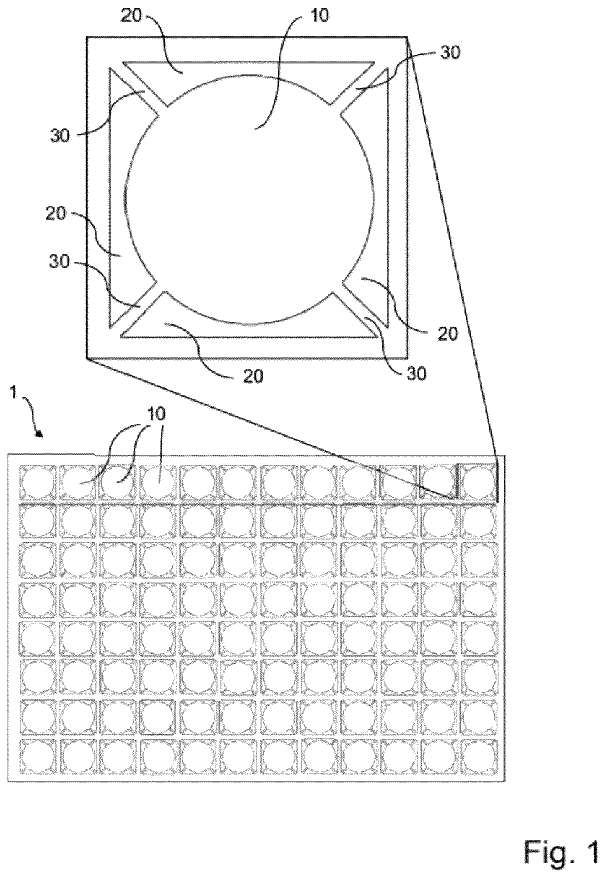

FIG. 1 shows a foil (1), in particular a membrane, with 96 foil areas (10), in particular membrane areas (bottom), arranged in a 12×8 matrix which are delimited by punchings (20). Furthermore, an enlargement of a single foil area (10), in particular membrane area, which is delimited by punchings (20) is shown, wherein the foil area (10), in particular the membrane area, is held in the foil (1), in particular in the membrane, by four connections (30), in particular by four webs (top).

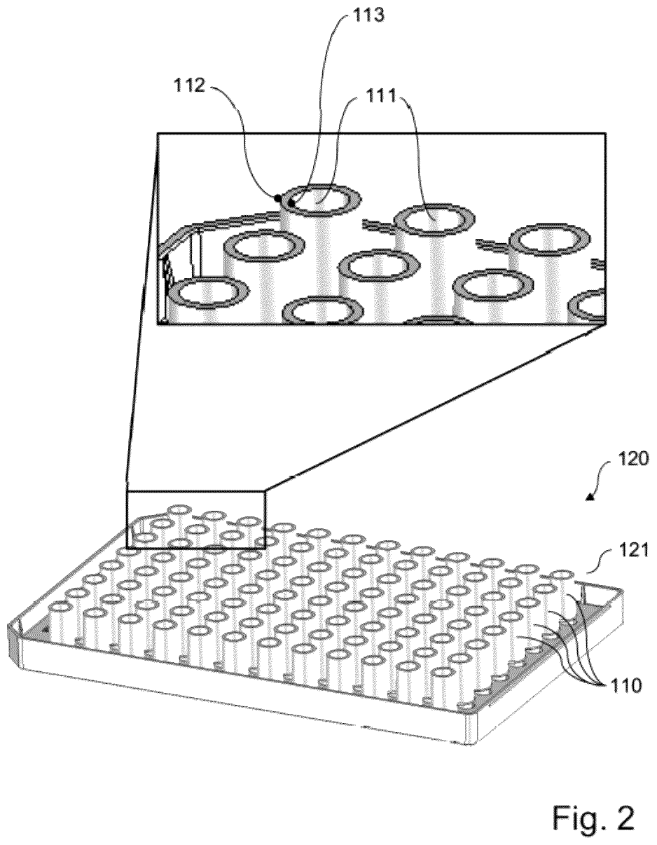

FIG. 2 shows the bottom side (121) of a workpiece (120), in particular of a multiwell plate, which comprises a plurality of cavities (110) with open ends (111). The enlarged section illustrates that the open ends (111) of the individual cavities (110) on the bottom side (121) of the workpiece (120), in particular of the multiwell plate, are each defined by an outer contour (112) and an inner contour (113).

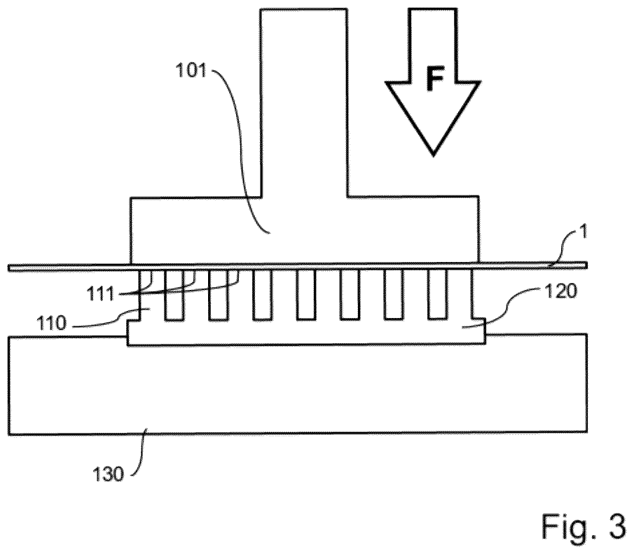

FIG. 3 shows the contacting of a heated stamp (101) with a foil (1), in particular membrane, which is placed on the open ends (111) of the cavities (110) of a workpiece (120), such that the individual foil areas (10), in particular membrane areas, of the foil (1), in particular of the membrane, bond with the workpiece (120), in particular with the multiwell plate, and the open ends (111) of the cavities (110) of the workpiece (120), in particular of the multiwell plate, are sealed. To fix the workpiece (120), in particular the multiwell plate, during contacting, it is preferably locked in place in a holding device (130).

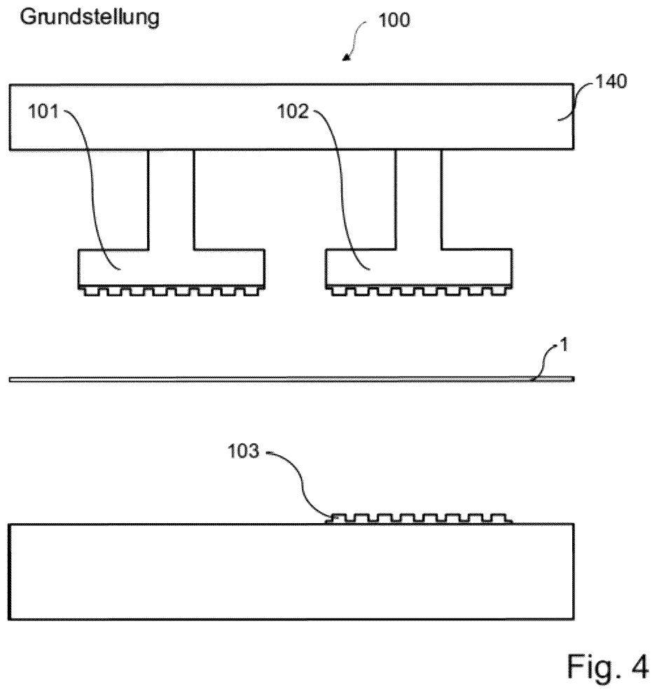

FIG. 4 shows a basic position of an apparatus (100) according to the invention in a schematic and simplified representation. In this basic position of the apparatus (100), there is still no workpiece (120) in the working area. A lower punching tool (103) is located in a lower vertical position. An upper punching tool (102) is arranged horizontally above the lower punching tool (103), wherein a foil (1) in the form of a foil web is arranged between the upper punching tool (102) the lower punching tool (103) and is preferably tensioned accordingly with a foil tension. A stamp (101) and a counter-pressure element—which is not shown—are arranged in a rest position. The upper punching tool (102) and the stamp (101) are jointly mounted above the foil (1) in a fixed position relative to one another in such a way that the upper punching tool (102) and the stamp (101) can jointly be moved in the horizontal direction and can each be separately moved in the vertical direction. In the embodiment shown here, the upper punching tool (102) and the stamp (101) are jointly arranged on a horizontally movable support (140) in a fixed position relative to one another.

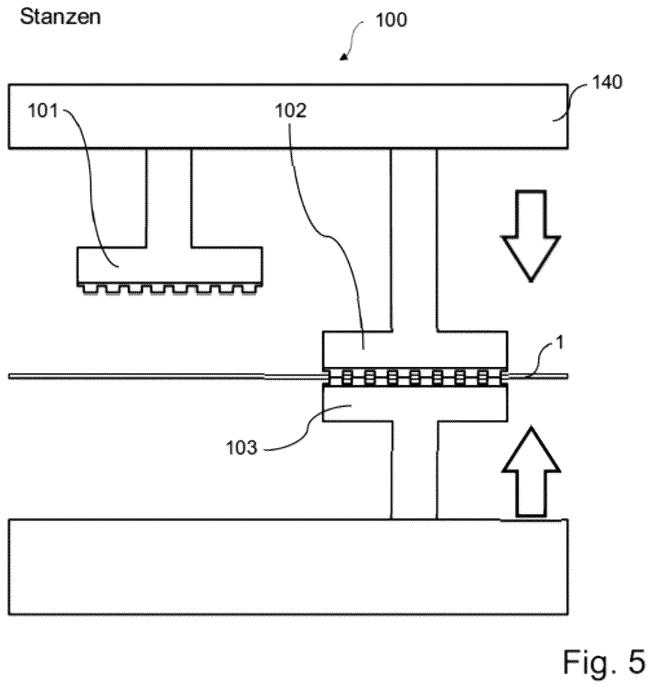

FIG. 5 shows the apparatus (100) during punching of the foil (1). For punching of the foil (1), the lower punching tool (103) is now moved vertically upwards within the working area in the direction of the foil (1) and the upper punching tool (102). The upper punching tool (102) is now lowered vertically onto the foil (1) and the lower punching tool (103) such that a punching of the foil (1) takes place. In particular, several cuts are made in the foil (1).

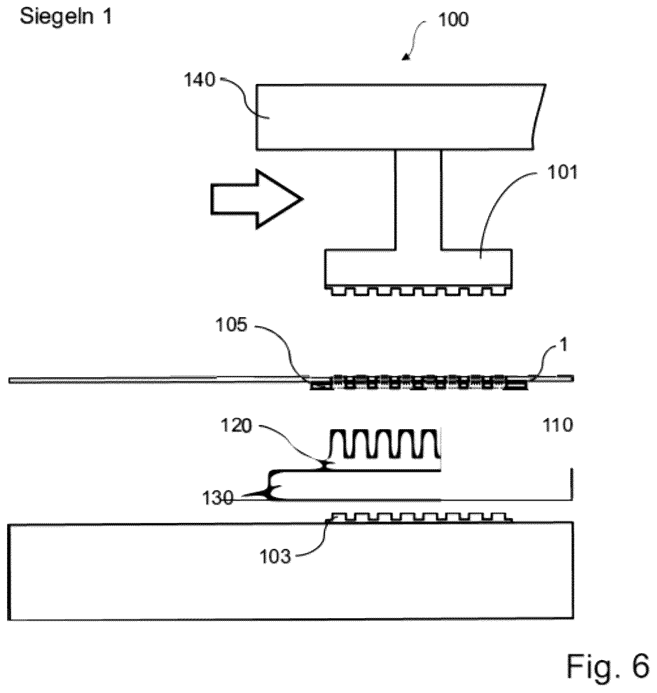

FIG. 6 shows the apparatus (100) in a standby position before sealing of a foil (1) onto a workpiece (120). After punching (see FIG. 5) of the foil (1), the lower punching tool (103) moves vertically downwards again and the upper punching tool (102) moves vertically upwards. In the embodiment shown here, the carrier (140) with the upper punching tool (102) and the stamp (101) is moved horizontally, such that the upper punching tool (102) is moved out of the working area and at the same time the stamp (101) is moved into the working area in a way that the stamp (101) is located at the same horizontal position at which the upper punching tool (102) was previously arranged. The foil (1) is not moved in the meantime. For sealing, a workpiece (120) in a holding device (130) is now brought into a horizontal position above the lower punching tool (103). Subsequently, a separation member (105) moves horizontally under the foil (1) and thus between the tensioned foil (1) and the workpiece (120). For this purpose, the separation member (105) comprises recesses through which the workpiece (120) and/or the stamp (101) can grab during sealing.

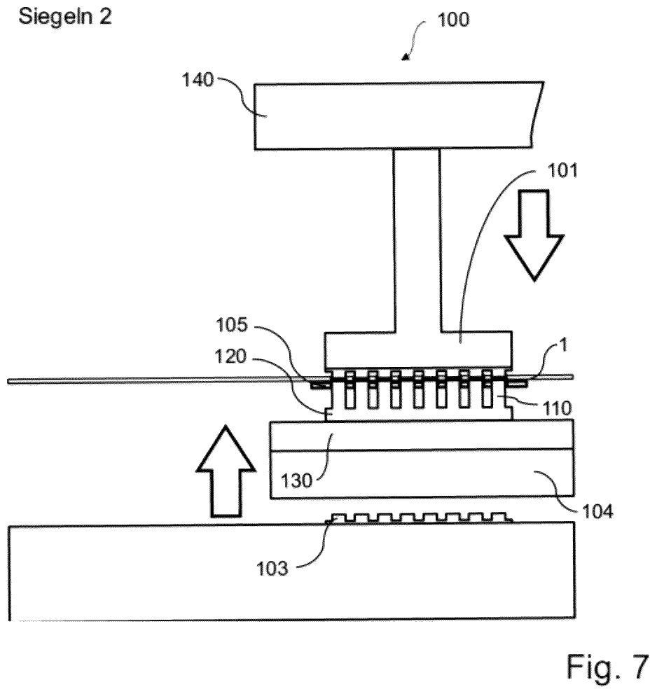

FIG. 7 shows the apparatus (100) during sealing of a workpiece (120) with a foil (1). First, the holding device (130) with the workpiece (120) is lifted. The lifting of the workpiece (120) can take place in several steps or in several stages, respectively, in order to provide the counter-pressure for the stamp (101) during sealing as a mechanical counter-bearing. The stamp (101) then moves down vertically onto the foil (1) and seals the pre-punched foil (1) onto the workpiece (120) using thermal energy and mechanical pressure. For this purpose, the stamp (101) is preferably designed have a number of convex projections as the stamp surface corresponding to the number of cavities (110) of the membrane bottom plate or of the workpiece (120), respectively. As a result, the thermal energy and the mechanical pressure exerted by the stamp (101) on the membrane bottom plate or the workpiece (120), respectively, acts specifically in the area of the cavities (110) and not over the entire surface of the entire membrane bottom plate or the entire workpiece (120) and/or the separation member (105) and can thus apply the energy in a targeted manner. In this way, damage to the membrane bottom plate or the workpiece (120), respectively, and/or to the membrane foil (1), in particular deformations, can be avoided.

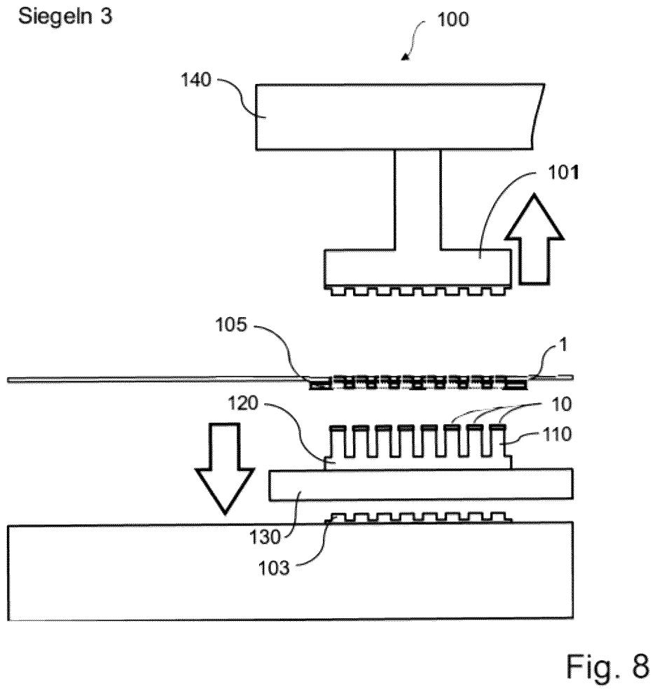

FIG. 8 shows the apparatus (100) after sealing a workpiece (120) with a foil (1). After sealing, the stamp (101) is moved vertically upwards and moved either separately into a rest position or jointly with the upper punching tool (102) within the common carrier (140). The holding device (130) with the workpiece (120) is then lowered again. By lowering the workpiece (120), the separation member (105) arranged directly under the foil (1) detaches the foil web of the foil (1) from the workpiece (120), such that the foil areas (10) sealed onto the workpiece (120) also detach from the foil (1).

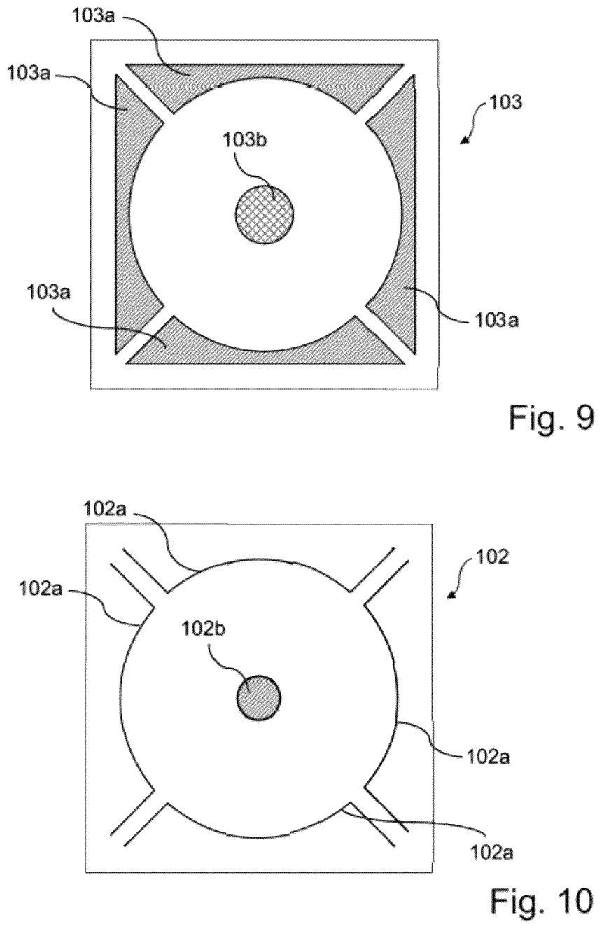

FIG. 9 shows a top view of the lower punching tool (103), wherein the hatched areas represent punch openings (103a) into which the punching blades (102a) of the upper punching tool (102) engage during punching. The lower punching tool (103) preferably has a movable release pin (103b), which is extended in the rest position and protrudes with its upper side from the surface of the lower punching tool (103). During punching, the release pin (103b) is pressed into the lower punching tool (103) by the upper punching tool (102), such that the release pin (103b) is then approximately flush with the surface of the lower punching tool (103). After punching has been completed, the release pin (103b) moves out of the lower punching tool (103) in the direction of the upper punching tool (102) again, in particular by means of spring force, so as to mechanically support the detachment of the foil (1) from the lower punching tool.

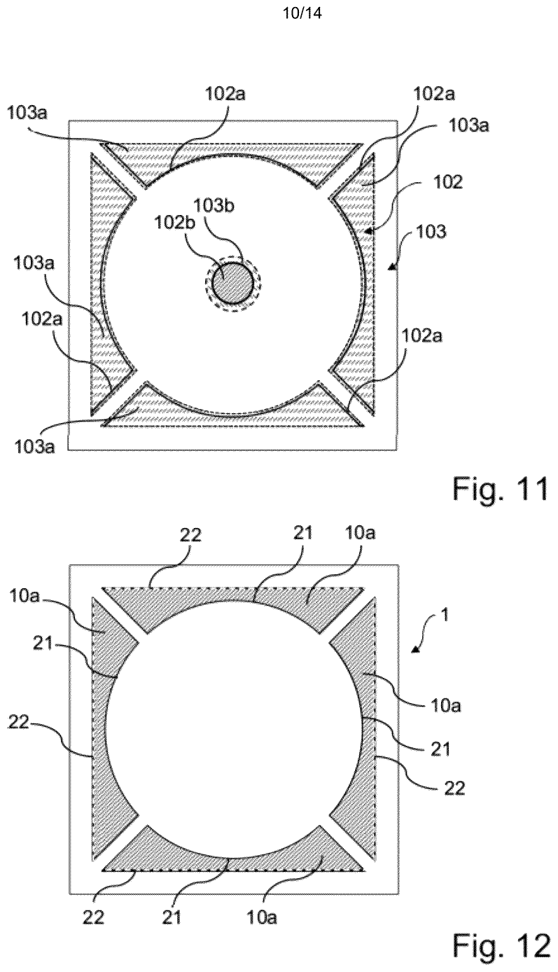

FIG. 10 shows the upper punching tool (102) with the punching blades (102a), which are preferably arranged movably in order to be recessed in the surface of the upper punching tool (102). In the rest position, the punching blades (102a) are arranged in the upper punching tool (102) in a recessed position so as to be protected from damage and/or contamination. The upper punching tool (102) further comprises an air opening (102b) so as to avoid air inclusions between the foil (1) and the surface of the upper punching tool (102) during merger of the tools, such that the foil (1) can be flat between both tools. The punch openings (103a) in the lower punching tool (103) also prevent corresponding air inclusions there. When the upper punching tool (102) is brought together with the lower punching tool (103), the punching blades (102a) are then extended accordingly so as to cut through the foil (1) between the two tools. FIG. 10 shows four punching blades which cut through or rather punch the foil (1) in such a way that loose foil sections in the form of loose waste are avoided. The punched foil sections remain attached to the residual foil.

FIG. 11 shows a combination of the lower punching tool (103) with the upper punching tool (102), wherein it is apparent that the punching blades (102a) of the upper punching tool (102) engage precisely in the correspondingly shaped punch openings (103a) of the lower punching tool (103). The punch openings (103a) are shown as dashed lines and the punching blades (102a) with a continuous thick line. It can be seen that the punching blades (103a) only engage on three of the four sides of a punching and that a fourth side is not punched.

FIG. 12 shows the completed punching similar to the enlarged representation in FIG. 1, wherein herein the punched foil section (10a) is highlighted in hatched lines. The cuts in the foil (1) are illustrated with continuous lines, along which the punched foil section (10a) is separated from the foil (1). A folding line (22) is shown with a dashed line, at which the punched foil section (10a) is still connected to the foil (1), whereby loose foil sections in the form of loose waste are avoided.

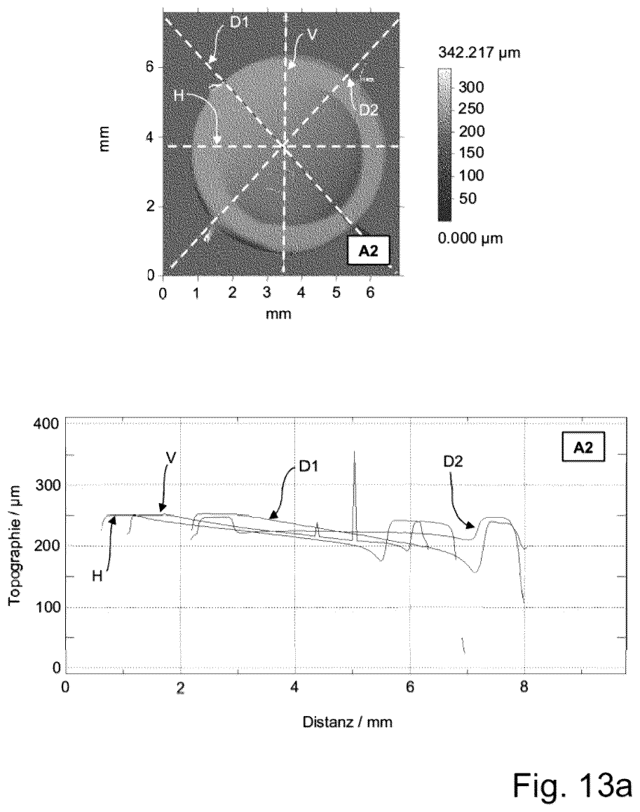

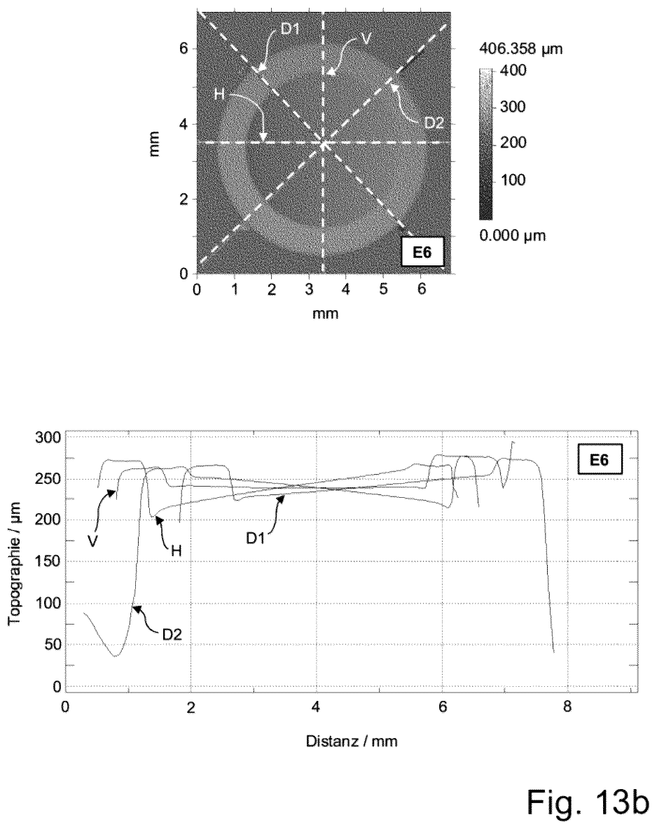

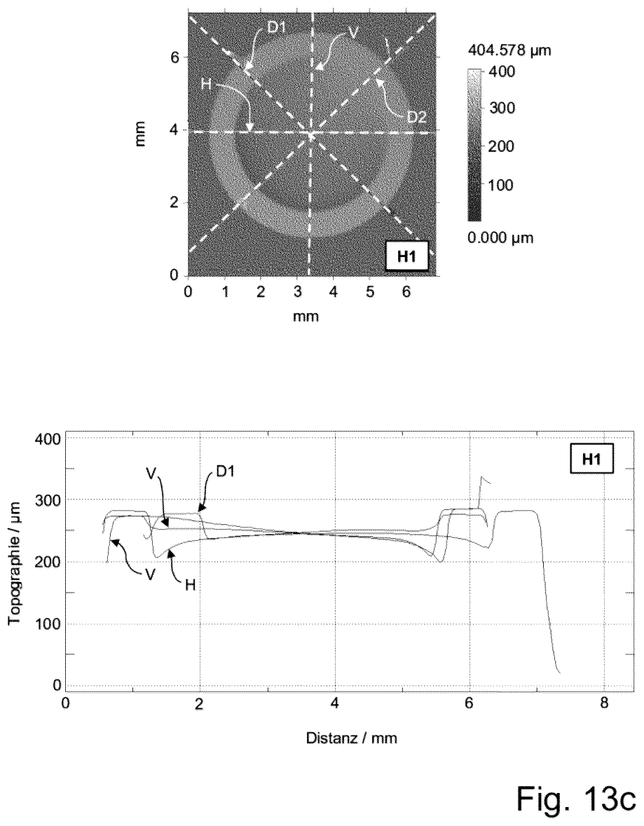

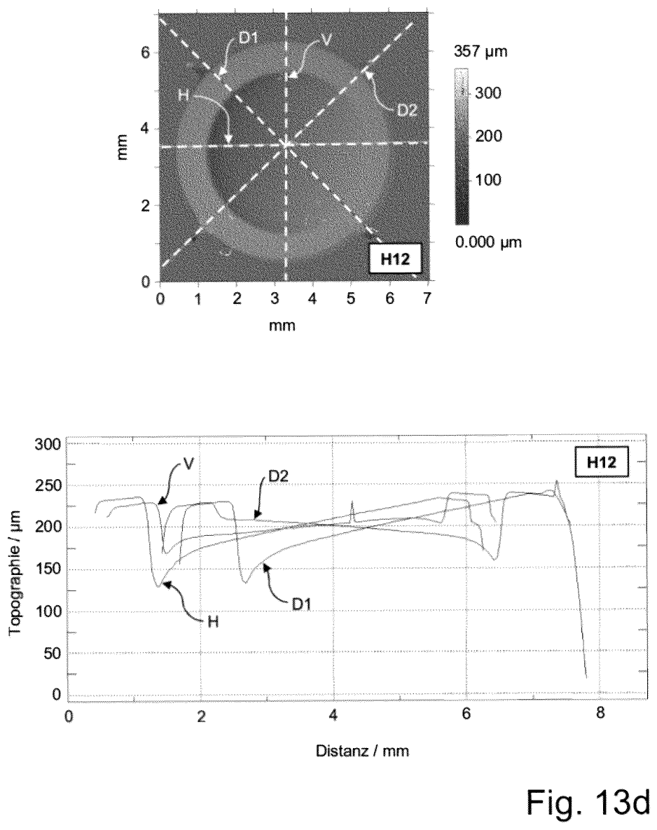

FIGS. 13a-d show the results of flatness measurements of foil bottoms of a membrane bottom plate produced by the method according to the invention.

The individual steps of the process carried out with an apparatus according to the invention are explained in detail and with reference to the figures below.

In a basic position of the apparatus (100) (FIG. 4), there is still no workpiece in the working area, wherein required workpieces are preferably arranged in a storage area. The lower punching tool (103) of the apparatus (100) is positioned in a lower vertical position. The upper punching tool (102) is arranged horizontally above the lower punching tool (103), wherein the foil (1), in particular membrane, is arranged between the upper punching tool (102) and the lower punching tool (103) in the form of a foil web, and is tensioned accordingly. The stamp (101) and the counter-pressure element (104) are arranged in a rest position.

Preferably, the upper punching tool (102) and the stamp (101) are arranged jointly on a horizontally movable carrier (140) in a fixed position with respect to one another such that, when the upper punching tool (102) is arranged in the working area above the lower punching tool (103), the stamp (101) is correspondingly positioned outside of the working area in the rest position. With a horizontal movement of the carrier (140), the upper punching tool (102) can then be moved out of the working area and thus the stamp (101) into the working area, in particular horizontally over a workpiece.

For punching of the foil (1), in particular of the membrane, the lower punching tool (103) is now moved vertically upwards in the working area in the direction of the foil (1), in particular of the membrane, and of the upper punching tool (102) (see FIG. 5). The lower punching tool (103) preferably has positioning aids for the upper punching tool (102), which are in particular designed as indentations. The upper punching tool (102) is now vertically lowered onto the foil (1), in particular onto the membrane, and on to the lower punching tool (103), such that the upper punching tool (102) and the lower punching tool (103) are closed and the foil (1), in particular the membrane, is punched. In the process, in particular several cuts are made in the foil (1), in particular in the membrane. The upper punching tool (102) preferably has positioning aids, which are in particular designed as cylindrical or conical pins or studs and can engage in the indentations of the lower punching tool (103). Preferably, the upper punching tool (102) has roller guides as positioning aids. Roller guides are cylindrical studs which have several movable roller bearings on their circumference, which securely and accurately hold the studs in position in the indentations of the lower punching tool (103). The web width of the foil (1), in particular of the membrane, is preferably dimensioned in such a way that the positioning aids are arranged within the working area and outside of the area occupied by the foil, in particular membrane.

After punching, the lower punching tool (103) preferably moves vertically downwards again and the upper punching tool (103) preferably moves vertically upwards. Preferably, the upper punching tool (102) moves horizontally out of the working area. Particularly preferred, the carrier (140) with the upper punching tool (102) and the stamp (101) is moved horizontally, such that the upper punching tool (102) moves out of the working area and at the same time the stamp (101) is moved into the working area, preferably to the same horizontal position in the working area at which the upper punching tool (102) was previously arranged. The foil (1), in particular the membrane, is not moved during this process.

For sealing, a workpiece (120) is now placed in a holding device (130) and introduced into the working area of the apparatus according to the invention (100), in particular brought into a horizontal position above the lower punching tool (103) (see FIG. 6). In a preferred embodiment, the introduction of the workpiece (120) in the holding device (130) takes place by means of a drawer, which is operated manually. The holding device (130) is positioned in the working area in such a way that the workpiece (120) is in the same horizontal position as the lowered lower punching tool (103) arranged below it. The foil (1), in particular the membrane, is not moved in the meantime. Now a separation member (105) preferably moves horizontally under the foil (1), in particular under the membrane, and thus between the tensioned foil (1), in particular the tensioned membrane, and the workpiece (120). For this purpose, the separation member (105) preferably has recesses through which the workpiece (120) and/or the stamp (101) can grab during sealing.

The stamp (101) now moves vertically onto the foil (1), in particular onto the membrane, while the holding device (130) with the workpiece (120) is lifted (see FIG. 7). The lifting of the workpiece (120) can take place in several steps or in several stages, respectively, in order to provide the counter-pressure for the stamp (101) during sealing as a mechanical counter-bearing. After the workpiece (120) in the holding device (130) has been lifted, preferably additional force assistance of the workpiece (120) in the holding device is provided by inserting a wedge under the holding device (130). The additional insertion of the wedge prevents damage to the lower punching tool (103). Now the stamp (101) moves down vertically onto the foil (1), in particular onto the membrane, and seals the already pre-punched foil (1), in particular the pre-punched membrane, onto the workpiece (120) by means of thermal energy and mechanical pressure, such that the parts of the workpiece (120) to be foiled are each sealed with a foil area (10), in particular with a membrane area. The stamp (101) is preferably shaped in such a way that it has a number of convex projections as the stamp surface corresponding to the number of cavities (110) of the membrane bottom plate or of the workpiece (120), respectively. As a result, the thermal energy and the mechanical pressure exerted by the stamp (101) on the membrane bottom plate or the workpiece (120), respectively, acts specifically in the area of the cavities (110) and not over the entire surface of the entire membrane bottom plate or the entire workpiece (120), respectively, and/or the separation member (105) and can thus apply the energy in a targeted manner. In this way, in particular damage to the membrane bottom plate or the workpiece (120), respectively, and/or the membrane foil (1), in particular deformations, can be avoided.

After sealing, the stamp (101) is moved vertically upwards again and is either separately or jointly together with the upper punching tool (102) within the common carrier (140) moved into a rest position. Subsequently, the holding device (130) with the workpiece (120) is lowered again (see FIG. 8). By lowering the workpiece (120) arranged in the holding device (130), the separation member (105) arranged directly under the foil (1), in particular under the membrane, detaches the foil web of the foil (1), in particular of the membrane, from the workpiece (120). The foiled workpiece (120) can then be removed from the working area, in particular by means of the optional drawer. The foil (1), in particular the membrane, is then moved horizontally in the feed direction at least to such an extent, in particular by at least the width of a punching and sealing area on the workpiece (120), that a yet unpunched area of the foil (1), in particular of the membrane, is available in the working area and can be punched and sealed onto a further workpiece (120) with the apparatus (100) in the next cycle.

In a particularly preferred embodiment of the present invention, the workpiece is a multiwell plate, preferably a membrane bottom plate, in particular a filter plate. Membrane bottom plates are characterized in that they comprise a plurality of cavities, the bottom of each of which is formed by a barrier layer, which is in particular a membrane. The individual cavities of a plate initially have two open ends, wherein at least one of the open ends has an inner contour and an outer contour. In the production of a membrane bottom plate, one of the open ends, in particular the end with an inner contour and an outer contour, is sealed with a foil, in particular with a membrane. Particularly preferred, the foil, in particular the membrane, has at least one foil area, in particular at least one membrane area, which is smaller than or equal in size as the outer contour of an open end of the at least one cavity and which is larger than the inner contour of the open end of the at least one cavity, wherein the at least one foil area, in particular the at least one membrane area, is delimited by at least one punching, and wherein the at least one foil area, in particular the at least one membrane area, is held in the foil, in particular in the membrane, by at least one connection, in particular after the punching and before the end of the sealing of the membrane area onto the open end of the cavity. In a preferred embodiment of the present invention, the at least one cavity has the shape of a cup. Preferably, the cup is concave in shape in the form of a depression when viewed from a first surface of the membrane bottom plate and convex in shape when viewed from a second surface (121) of the membrane bottom plate lying opposite from the first surface of the membrane bottom plate. The membrane is preferably sealed onto the open outer convex end of the at least one cavity of the membrane bottom plate from the second surface (121) side.

According to this preferred embodiment, the holding device (130) of the apparatus (100) according to the invention is shaped accordingly so as to receive the membrane bottom plate in a way that the at least one cavity with the open end to be sealed, in particular with its convex end and thus with its second surface, faces the stamp (101) and that the first surface faces the counter-pressure element (104).

According to this embodiment, the optional separation member (105) of the apparatus (100) is shaped in a way that it has at least one recess which extends through the at least one cavity (100) such that the at least one outer open end of the at least one cavity (110) is flash with the surface of the separation member (105) facing the stamp (101) or protrudes slightly or is slightly below the surface of the separation member (105), such that the stamp (101) can seal the foil (1), in particular the membrane, onto the at least one cavity (110) of the membrane bottom plate within the recess of the separation member (105).

Preferably, the membrane bottom plate has a plurality of cavities, in particular at least 2, preferably at least 6, preferably at least 12, preferably at least 24, preferably at least 48, preferably at least 96, preferably at least 384, preferably at least 1536, preferably at least 3456, cavities.

The stamp is preferably shaped in such a way that the stamp has a number of convex projections as the stamp surface corresponding to the number of cavities of the membrane bottom plate or of the workpiece, respectively. As a result, the thermal energy and the mechanical pressure exerted by the stamp on the membrane bottom plate or the workpiece, respectively, acts specifically in the area of the cavities and not over the entire surface of the entire membrane bottom plate or the entire workpiece, respectively, and/or the separation member and can thus apply the energy in a targeted manner. In this way, in particular damage to the membrane bottom plate or the workpiece, respectively, and/or the membrane foil, in particular deformations, can be avoided.

Particularly preferred, the stamp has a stamp surface corresponding to the part of the workpiece to be foiled, in particular to the membrane bottom plate. For workpieces to be foiled that are shaped differently from the membrane bottom plate, the stamp can also have a differently shaped stamp surface. In particular, the stamp surface can be designed with an entirely flat surface for other workpieces to be foiled, such that no adaptation of the stamp surface to the foil areas, in particular membrane areas, and/or to the at least one part of the workpiece to be foiled is necessary. For other workpieces, the stamp surface can have one or more projections as stamp surface, which partially correspond to the foil areas, in particular the membrane areas, and/or the at least one part of the workpiece to be foiled and at the same time, the stamping surface can have other areas as stamp surface, which do not correspond to the foil areas, in particular the membrane areas, and/or to the at least one part of the workpiece to be foiled.

The embodiments mentioned in connection with the method for producing a foiled workpiece, in particular a membrane bottom plate, according to the invention also apply mutatis mutandis to the foiled workpiece, in particular to the membrane bottom plate, according to the invention, to the system according to the invention, in particular to the membrane bottom plate system, and to the apparatus according to the invention, and vice versa.

Further preferred embodiments of the present invention are subject-matter of the subclaims.

### EXAMPLES

### Example 1: Method for Producing a Filter Bottom Plate

Step 1: Pre-punching of 96 membrane areas in a translucent polycarbonate (PC) membrane having a thickness of 25 μm, an average pore size of 0.4 μm and a porosity of 12.6 %.
Step 2: Positioning a multiwell plate having 96 wells with open ends (material: polycarbonate, glass transition temperature 140 °C) under the pre-punched membrane such that the 96 pre-punched membrane areas come into congruence with the open ends of the wells.
Step 3: Sealing the pre-punched membrane areas onto the open ends of the 96 wells of the plate by hot stamping. In this process, the sealing is carried out using a silicone stamp that reproduces the contour of the wells. The temperature of the stamp is 150 °C±5 °C. The sealing force with which the stamp is pressed onto the plate is 3.2 kN. The stamp is pressed on for a time of 1.6 seconds.
Step 4: After sealing, the plate is passively cooled in ambient air for 4 seconds before it is separated from the membrane and can be removed.

### Example 2: Flatness Measurement

The filter bottom plate having 96 wells or cavities, respectively, as produced by the method according to the invention described to example 1 was subjected to a flatness measurement. For this purpose, individual wells of the plate sealed with a foil were examined for flatness of the foil bottom using a MicroProf 100 white light interferometer (FRT Metrology). The flatness measurement was carried out manually with the program Aquire, wherein the foil bottoms of four representative wells or cavities, respectively, (A2 (FIG. 13a), E6 (FIG. 13b), H1 (FIG. 13c) and H12 (FIG. 13d)) were measured from four different directions (horizontal (H), vertical (V) and diagonal (D1, D2)).

The measurement showed an excellently high flatness or a low flatness tolerance, respectively, of all foil bottoms measured (FIGS. 13a-d).

### LIST OF REFERENCE SIGNS

Foil 1
Foil area 10
Punched foil section 10a
Punching 20
Cutting line 21
Folding line 22
Connection 30
Apparatus 100
Stamp 101
Upper punching tool 102
Punching blade 102a
Air opening 102b
Lower punching tool 103
Punch openings 103a
Release pin 103b
Counter-pressure element 104
Separation member 105
Cavity 110
Open end of the cavity 111
Outer contour of the cavity 112
Inner contour of the cavity 113
Workpiece 120
Holding device 130
Carrier 140

1. A method of producing a foiled workpiece, comprising the steps of:
a) providing a workpiece made of a first material,
b) providing a foil made of a second material, wherein the foil has at least one foil area which is delimited by at least one punching, and wherein the at least one foil area is held in the foil by means of at least one connection,
c) contacting the workpiece with the foil such that the at least one foil area of the foil comes into congruence with a part of the workpiece to be foiled,
d) contacting a stamp with the foil such that the at least one foil area bonds with the workpiece and seals the part of the workpiece to be foiled, wherein the stamp has a temperature which is above the glass transition temperature of the first and/or second material, and
e) removing the heated stamp to obtain a foiled workpiece.

2. The method according to claim 1, wherein the workpiece provided in step a) is a plate, in particular a multiwell plate.

3. The method according to claim 1, wherein the foil has a thickness of 10 μm to 50 μm.

4. The method according to claim 1, wherein at least one foil area is held in the foil by at least two connections.

5. The method according to claim 1, wherein before step b), preferably before step a) and step b), a punching of a foil is carried out in a step a1) to obtain the foil provided in step b).

6. The method according to claim 5, wherein the method is carried out in an apparatus for producing a foiled workpiece according to claim 14.

7. The method according to claim 6, comprising the substeps:
i. Moving the lower punching tool vertically upwards below the foil,
ii. Moving the upper punching tool vertically downwards and pressing the upper punching tool against the lower punching tool such that the upper punching tool and the lower punching tool are in a closed state and the foil between the upper punching tool and the lower punching tool is punched,
iii. Moving the lower punching tool vertically downwards and moving the upper punching tool vertically upwards such that the punched foil is released,
iv. Moving the stamp horizontally into a position above a workpiece arranged in the holding device such that the punched foil is located between the stamp and the workpiece,
v. Moving the holding device with the workpiece vertically upwards,
vi. Moving the stamp vertically downwards onto the workpiece arranged in the holding device, such that the punched foil is sealed onto the workpiece,
vii. Moving the holding device vertically downwards and moving the stamp (101) vertically upwards,
viii. Removing the foiled workpiece from the holding device.

8. The method according to claim 1, wherein the part of the workpiece to be foiled is an open end of at least one cavity of the workpiece.

9. The method according to claim 1, wherein the foil has a number of foil areas corresponding to a number of parts of the workpiece to be foiled, in particular to the number of cavities of the workpiece, wherein the foil areas are each smaller than or equal in size as an outer contour of the part of the workpiece to be foiled, in particular as an outer contour of an open end of the cavities, wherein the foil areas are larger than an inner contour of the part of the workpiece to be foiled, in particular as an inner contour of an open end of the cavities, and wherein the foil areas are each delimited by a punching.

10. The method according to claim 1, wherein the stamp has a temperature which is at most 5 °C, preferably at most 10 °C, above the glass transition temperature of the first and/or second material during contacting with the foil in step d).

11. The method according to claim 1, wherein the contacting of the stamp with the foil in step d) takes place at a temperature of 120 to 180 °C and for a time of at most 4 seconds.

12. The method according to claim 1, wherein in an additional step f), a separation of the at least one foil area being bonded to the workpiece and sealing the at least one part of the workpiece to be foiled from the foil takes place, wherein the separation takes place by a movement of the workpiece relative to the foil.

13. The method according to claim 1, wherein the foil is a polycarbonate (PC) membrane having an average pore size of 0.05 μm to 15 μm, preferably 0.2 μm to 10 μm.

14. An apparatus for producing a foiled workpiece, comprising:
i) at least one lower punching tool and at least one upper punching tool,
ii) at least one foil,
iii) at least one stamp,
iv) at least one holding device for holding a workpiece to be foiled,
wherein the upper punching tool and the stamp are each arranged vertically movable upwards and downwards on a horizontally movable common carrier
wherein the lower punching tool is vertically movable upwards and downwards, and
wherein the holding device can be moved vertically upwards and can be brought into a position above the lower punching tool and below the foil and the stamp with a workpiece to be foiled arranged therein.

15. The apparatus according to claim 14, wherein a punching of the foil between the lower punching tool and the upper punching tool and a sealing of the foil onto a workpiece to be foiled which is arranged in the holding device are carried out at the same horizontal position in the apparatus.

16. A foiled workpiece, producible by a method according to claim 1.

17. The foiled workpiece according to claim 16, wherein the foiled workpiece is a membrane bottom plate.

18. The foiled workpiece according to claim 17, wherein the membrane bottom plate has at least one cavity, of which an open end is sealed by a foil area, wherein the foil area sealing the open end of the at least one cavity of the membrane bottom plate has a flatness tolerance of at most 200 μm, preferably at most 150 μm.

19. The foiled workpiece according to claim 17, wherein the membrane bottom plate has at least two cavities, each of which having one open end which is sealed by a foil area, wherein the flatness tolerance averaged from the flatness tolerances of all foil areas of the membrane bottom plate is at most 200 μm, preferably at most 150 μm.

20. A membrane bottom plate system, comprising a foiled workpiece according to claim 17, a receiver plate and a lid.
